(19) United States
(12) Patent Application Publication
(10) Pub. No.: US 2020/0100128 A1
(43) Pub. Date: Mar. 26, 2020

(54) Flexible Measurement Reporting in Multi-Radio Access Technology Scenarios

(71) Applicant: Telefonaktiebolaget LM Ericsson (publ), Stockholm (SE)

(72) Inventors: Rui Fan, Beijing (CN); Icaro L. J. da Silva, Solna (SE); Oumer Teyeb, Solna (SE)

(21) Appl. No.: 16/300,697

(22) PCT Filed: Sep. 28, 2018
(86) PCT No.: PCT/SE2018/050993

§ 371 Date: Nov. 12, 2018

Related U.S. Application Data
(60) Provisional application No. 62/564,774, filed on Sep. 28, 2017.

(51) Int. Cl. H04W 24/10; H04W 76/16

(52) U.S. Cl. CPC H04W 24/10; H04W 88/06; H04W 76/16

(57) ABSTRACT

According to an aspect, a wireless device (50) is configured to support simultaneous connections to one or more serving cells in a first radio access network (RAN), using a first radio access technology (RAT) and to one or more serving cells in a second RAN, using a second RAT that differs from the first RAT. The wireless device (50) receives, from a base station (30) in the first RAN, using the first RAT, measurement configuration information, where the measurement configuration information indicates whether radio measurements performed by the wireless device (50) on serving cells in the second RAN should be reported to the first RAN, using the first RAT. The wireless device (50) selectively reports measurement data for radio measurements performed by the wireless device (50) on serving cells in the second RAN to the first RAN, using the first RAT, in accordance with the measurement configuration information.

### TECHNICAL FIELD

The present disclosure generally relates to the field of wireless network communications, and more particularly, to a wireless device configured to support simultaneous connections to serving cells in a first radio access network (RAN), using a first radio access technology (RAT), and to serving cells in a second RAN, using a second RAT that differs from the first RAT.

### BACKGROUND

The Evolved Packet Subsystem (EPS) is the Evolved 3GPP Packet Switched Domain and includes the Evolved Packet Core (EPC) and Evolved Universal Terrestrial Radio Access Network (E-UTRAN), as defined by members of the 3rd-Generation Partnership Project (3GPP). The EPC architecture is defined in 3GPP TS 23.401, which provides definitions of the PGW (PDN Gateway), SGW (Serving Gateway), PCRF (Policy and Charging Rules Function), MME (Mobility Management Entity), and UE (user equipment—3GPP terminology for an access terminal, such as a mobile telephone, machine-to-machine wireless device, etc.). The Long-Term Evolution (LTE) radio access, E-UTRAN, includes one or more eNBs (3GPP terminology for LTE base stations; also referred to as eNodeBs).

The overall E-UTRAN architecture is further defined, for example, in 3GPP TS 36.300. The E-UTRAN includes eNBs, providing the E-UTRA user plane (PDCP/RLC/MAC/PHY or Packet Data Convergence Protocol/Radio Link Control/Medium Access Control/Physical Layer) and control plane (Radio Resource Control, or RRC) protocol terminations towards the UE. The eNBs are interconnected with each other by means of the X2 interface. The eNBs are also connected by means of the S1 interface to the EPC (Evolved Packet Core), more specifically to the MME (Mobility Management Entity) by means of the S1-MME interface and to the Serving Gateway (S-GW) by means of the S1-U interface.

LTE Dual Connectivity (DC)

LTE Dual Connectivity (DC) is standardized in Release 12 of the 3GPP specifications (3GPP Rel-12) to enable UEs to send and receive data on multiple carriers at the same time (e.g., multiple TX/RX). As described in 3GPP TS 36.300, E-UTRAN supports DC operation whereby a multi-transceiver (Rx/Tx) UE in RRC_CONNECTED is configured to utilize radio resources provided by two distinct schedulers, located in two eNBs (base stations) connected via a non-ideal backhaul over the X2 interface (see 3GPP TR 36.300). eNBs involved in DC may assume one of two different roles for a given UE: an eNB may either act as an MeNB (Master eNB or MN) or as an SeNB (Secondary eNB or SN). In DC, a UE is connected to one MN and one SN. An eNB can act both as an MN and an SN at the same time, for different UEs.

In LTE DC, the radio protocol architecture that a particular bearer uses depends on how the bearer is setup. Three bearer types are MCG (Master Cell Group) bearer, SCG (Secondary Cell Group) bearer, and split bearer. RRC is managed in a MeNB, and SRBs (Signaling Radio Bearers) are always configured as MCG bearer type and therefore only use the radio resources of the MeNB. Only MeNB has RRC connection with UE, therefore, only MeNB can send RRC signaling toward UE. For mobility measurements, MeNB configures a UE for which frequency to measure and how to report, etc. Correspondingly, the UE sends measurement results to the MeNB once a criterion is met. Note that DC can also be described as having at least one bearer configured to use radio resources provided by the SeNB.

Inter-eNB control plane signaling for DC is performed by means of X2 interface signaling. Control plane signaling towards the MME is performed by means of S1 interface signaling. There is only one S1-MME connection per DC UE between the MeNB and the MME. Each eNB should be able to handle UEs independently, i.e., provide the PCell to some UEs while providing SCell(s) for SCG to others. Each eNB involved in DC for a certain UE controls its radio resources and is primarily responsible for allocating radio resources of its cells. Respective coordination between MeNB and SeNB is performed by means of X2 interface signaling.

According to LTE principles, when a UE needs to send a measurement report, due to a triggered event or due to periodic trigger, the UE should always send measurement results for the serving cell to the network. For UE in LTE-DC, the term “serving cell” means both cells in MCG (MN) and cells in SCG (SN).

NR Dual Connectivity and LTE-NR Tight Interworking

3GPP has now continued with the effort to standardize a new radio interface for 5G, often referred to as NR (New Radio). LTE-NR DC (also referred to as LTE-NR tight interworking) is being defined for Release 15 of the 3GPP specifications. In this context, major changes from LTE DC include the introduction of split bearer from the SN (known as SCG split bearer). The SN in this particular case is also referred to as SgNB (secondary gNB, where gNB denotes the NR base station). Major changes also include the introduction of split bearer for RRC (known as split SRB) and the introduction of a direct RRC from the SN (known as SCG SRB or direct SRB). FIGS. 1 and 2 show the User Plane (UP) and Control Plane (CP) architectures for NR dual connectivity and LTE-NR tight interworking.

From FIGS. 1 and 2, it can be seen that separate SRBs are supported both from the MN and SN. This means that a UE can receive signaling messages, or RRC messages, both from the MN and the SN. There will thus be two RRC instances responsible for controlling the UE—one directed from the MN and another from the SN in the depicted scenario.

The consequence of this architecture is that the UE needs to terminate RRC signaling from two instances: both from the MN and the SN. The motivation for introducing such multiple RRC instances in NR DC, and in particular for LTE-NR DC, is that the MN and SN will partly be autonomously responsible for the control of radio resources. For example, the MN is allocating resources from some spectrum used for LTE, while the SN will be responsible for configuring and allocating resources from some other spectrum allocated to NR. As challenges for allocating resources in LTE and NR may differ substantially (e.g., since NR might be allocated in a spectrum where beam-forming is highly desirable, while LTE might be allocated in a spectrum with good coverage but with very congested resources), it is important that the SN has some level of autonomy to configure and manage the UE on resources associated with the SN. On the other hand, the overall responsibility for connectivity to the UE will likely be at the MN node, so the MN node has the overall responsibility, for example, for mobility, state changes of the UE, for meeting quality of service demands of the UE, etc.

The MN and SN may be nodes that use LTE (4G) or NR (5G) radio access technologies. They may both support the same technology, or they may support different technologies.

In the current work in 3GPP, a first objective is to support the scenario where the MN uses LTE, connected to the Evolved Packet Core (EPC) and the SN uses NR. In In this scenario, the NR node (SN in this scenario) is not connected directly to the core-network, but all traffic to and from the UE is carried via the MN from/to the EPC. This scenario is also known as non-stand-alone NR. In addition to addressing this objective, 3GPP will likely pursue standardization efforts that encompass other scenarios, such as when the NR node (also called gNB, i.e., a base-station supporting NR radio) is connected to the Next Generation Core and acts as an MN. Dual connectivity for NR includes many scenarios, such as where: the MN supports LTE and SN supports NR discussed above (also called NR “non-stand-alone”); the MN supports NR and the SN supports LTE; and both MN and SN are NR.

From the UE perspective, both the cells it operates in LTE and the cells it operates in NR are its serving cells.

The following terminologies are used throughout this text to differentiate different dual connectivity scenarios: DC: LTE DC (i.e. both MN and SN employ LTE); EN-DC: LTE-NR dual connectivity where LTE is the master and NR is the secondary; NR-DC (or NR-NR DC): both MN and SN employ NR; and MR-DC (multi-RAT DC), which is a generic term to describe where the MN and SN employ different RATs (EN-DC is one example of MR-DC).

NR Measurement Model

The network can configure a UE to perform NR cell level measurements as in LTE. However, in contrast to LTE, where for cell level measurements the UE uses cell-specific reference signals, in NR, the network can configure which reference signal (RS) type to be used: SS/PBCH block (Synchronization Signal/Physical Broadcast Channel block) or CSI-RS (Channel State Information Reference Signal).

In addition to this flexibility of selecting a RS Type, another difference compared to LTE is that these reference signals can be beamformed and transmitted in different beams, especially when NR is deployed in higher frequencies. In that sense, for each RS type and for each cell, the UE may detect multiple beams where each beam has an RS index. For SS/PBCH block, there will be some kind of beam identifier encoded by the combination of the PBCH/DMRS (Physical Broadcast Channel/Demodulation Reference Signal) sequence identifier and possibly an explicit time index encoded in PBCH. For CSI-RS, there will be a configurable CSI-RS resource index. Each of these beams are first processed by implementation dependent L1 filters and used as input for the cell quality calculation where the cell measurement result can either be the best beam value or the average of the best beam with other beams above a configurable absolute threshold.

In addition, the network can also configure the UE to perform L3 filtering of beam-specific measurements from the L1 filters and include these in measurement reports. The NR measurement model is summarized as follows, as described in 3GPP TS 38.300:

In RRC_CONNECTED, the UE measures multiple beams (at least one) of a cell and the measurements results (power values) are averaged to derive the cell quality. In doing so, the UE is configured to consider a subset of the detected beams: the best and the N−1 best beams above a configurable absolute threshold. The network can also configure the UE to perform L3 filtered beam level measurements to be included in measurement reports. FIG. 3 shows a measurement model. Note that the K beams in FIG. 3 correspond to the measurements on NR-SS block or CSI-RS resources configured for L3 mobility by gNB and detected by UE at L1. The corresponding high-level measurement model is described below:

A: measurements (beam specific samples) internal to the physical layer.

Layer 1 filtering: internal layer 1 filtering of the inputs measured at point A. Exact filtering is implementation dependent. How the measurements are actually executed in the physical layer by an implementation (inputs A and Layer 1 filtering) in not constrained by the standard.

A¹: measurements (i.e. beam specific measurements) reported by layer 1 to layer 3 after layer 1 filtering.

Beam Consolidation/Selection: beam specific measurements are consolidated to derive cell quality if N>1, else when N=1 the best beam measurement is selected to derive cell quality. The behavior of the Beam consolidation/selection is standardized and the configuration of this module is provided by RRC signaling. Reporting period at B equals one measurement period at A¹.

B: a measurement (i.e. cell quality) derived from beam-specific measurements reported to layer 3 after beam consolidation/selection.

Layer 3 filtering for cell quality: filtering performed on the measurements provided at point B. The behavior of the Layer 3 filters is standardized and the configuration of the layer 3 filters is provided by RRC signaling. Filtering reporting period at C equals one measurement period at B.

C: a measurement after processing in the layer 3 filter. The reporting rate is identical to the reporting rate at point B. This measurement is used as input for one or more evaluation of reporting criteria.

Evaluation of reporting criteria: checks whether actual measurement reporting is necessary at point D. The evaluation can be based on more than one flow of measurements at reference point C e.g. to compare between different measurements. This is illustrated by input C and C¹. The UE shall evaluate the reporting criteria at least every time a new measurement result is reported at point C, C¹. The reporting criteria are standardized and the configuration is provided by RRC signaling (UE measurements).

D: measurement report information (message) sent on the radio interface.

L3 Beam filtering: filtering performed on the measurements (i.e. beam specific measurements) provided at point A¹. The behavior of the beam filters is standardized and the configuration of the beam filters is provided by RRC signaling. Filtering reporting period at E equals one measurement period at A¹.

E: a measurement (i.e. beam-specific measurement) after processing in the beam filter. The reporting rate is identical to the reporting rate at point A¹. This measurement is used as input for selecting the X measurements to be reported.

Beam Selection for beam reporting: selects the X measurements from the measurements provided at point E. The behavior of the beam selection is standardized and the configuration of this module is provided by RRC signaling.

F: beam measurement information included in measurement report (sent) on the radio interface.

Layer 1 filtering introduces a certain level of measurement averaging. How and when the UE exactly performs the required measurements is implementation specific to the point that the output at B fulfils the performance requirements set in 3GPP TS 38.133. Layer 3 filtering for cell quality and related parameters used are specified in 3GPP TS 38.331 and does not introduce any delay in the sample availability between B and C. Measurement at point C, is the input used in the event evaluation. L3 Beam filtering and related parameters used are specified in 3GPP TS 38.331 and do not introduce any delay in the sample availability between E and F.

### SUMMARY

A problem with previous measurement solutions is that so far, in LTE, serving cells have always been associated to E-UTRA frequencies. E-UTRA specifications define that these serving cells shall always be measured and shall always be included in measurement reports as there are many actions that the network can take, regarding LTE mobility and DC setup/release, etc., that can rely on these measurements.

However, in EN-DC, the UE will have LTE serving cells in the MCG (PCell and SCells) and NR serving cells in the SCG (PSCell and SCells), a scenario that is not addressed by previous measurement solutions. It is then unclear what shall be the UE actions regarding the measurements of NR serving cells. The existing solution in LTE is not applicable, as the very same actions the network can do in LTE based on LTE measurement reports of serving cells may not be possible or desired in EN-DC based on NR serving cell measurement reports.

In EN-DC there can be MN-centric scenarios, where SN mobility decisions can be taken by the MN, or SN-centric scenarios, where SN mobility decisions are taken by the SN. A combination of the two can also be envisioned.

In SN-centric scenarios, LTE MN is only interested to know the measurement results from LTE serving cell, similarly NR SN is only interested to know the measurement results from NR serving cell.

In MN-centric scenarios, on the other hand, the LTE solution of only having LTE measurements would make difficult to the MN to take NR mobility decisions. For example, for MN initiated SN change, it would be very useful for LTE MN to know the quality of NR serving cells so that LTE MN can know whether or not to change the SN.

In addition, NR defines new types of measurements that can be reported compared to LTE. Given the NR measurement model described above, a UE can be configured in NR to report L3 filtered beam-specific measurement results (e.g. SS-RSRP, SS-RSRQ, SS-SINR, CSI-RSRP, CSI-RSRQ and CSI-SINR) where these are L3 filtered per reference signal index.

Embodiments of the present invention address these problems. These embodiments include methods whereby the UE performs and reports inter-RAT serving cell measurements. In some cases, the manner by which the UE performs these measurements and the reporting of these measurement is configurable by the network, to minimize unnecessary overhead and to make the report adaptable for different network scenarios/deployments.

These serving cell measurements may be: RSRP, RSRQ, SINR per cell; or RSRP, RSRQ, SINR per beam where a beam can be indicated as a reference signal index.

Advantages of several of the embodiments described herein include that the cost for the UE to send unnecessary measurement results can be avoided, while the network can get necessary measurement results when needed, providing a higher degree of flexibility on what node take SN change decisions, whether it is the MN or the SN.

According to some embodiments, a method, in a wireless device configured to support simultaneous connections to one or more serving cells in a first RAN, using a first RAT and to one or more serving cells in a second RAN using a second RAT that differs from the first RAT, includes receiving, from a base station in the first RAN, using the first RAT, measurement configuration information, the measurement configuration information indicating whether radio measurements performed by the wireless device on one or more of the serving cells in the second RAN should be reported to the first RAN, using the first RAT. The method also includes selectively reporting measurement data for radio measurements performed by the wireless device on one or more of the serving cells in the second RAN to the first RAN, using the first RAT, in accordance with the measurement configuration information.

According to some embodiments, a method, in a base station in a first RAN, where the base station is configured to support simultaneous connections by a wireless device to the base station using a first RAT and to one or more serving cells in a second RAN using a second RAT that differs from the first RAT, includes sending, to the wireless device, using the first RAT, measurement configuration information, the measurement configuration information indicating whether radio measurements performed by the wireless device on one or more of the serving cells in the second RAN should be reported to the first RAN, using the first RAT.

According to some embodiments, a wireless device configured to support simultaneous connections to one or more serving cells in a first RAN, using a first RAT and to one or more serving cells in a second RAN, using a second RAT that differs from the first RAT, includes transceiver circuitry configured for communicating with the serving cells in the first and second RANs and processing circuitry operatively associated with the transceiver circuitry. The processing circuitry is configured to receive, from a base station in the first RAN, using the first RAT, measurement configuration information, the measurement configuration information indicating whether radio measurements performed by the wireless device on one or more of the serving cells in the second RAN should be reported to the first RAN, using the first RAT. The processing circuitry is also configured to selectively report measurement data for radio measurements performed by the wireless device on one or more of the serving cells in the second RAN to the first RAN, using the first RAT, in accordance with the measurement configuration information.

According to some embodiments, a base station in a first RAN, where the base station is configured to support simultaneous connections by a wireless device to the base station using a first RAT and to one or more serving cells in a second RAN using a second RAT that differs from the first RAT, includes transceiver circuitry configured for communicating with the serving cells in the first and second RANs and processing circuitry operatively associated with the transceiver circuitry. The processing circuitry is configured to send, to the wireless device, using the first RAT, measurement configuration information, the measurement configuration information indicating whether radio measurements performed by the wireless device on one or more of the serving cells in the second RAN should be reported to the first RAN, using the first RAT.

Further aspects of the present invention are directed to an apparatus, computer program products or computer readable storage medium corresponding to the methods summarized above and functional implementations of the above-summarized apparatus and wireless device.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE FIGURES

FIG. 1 illustrates LTE-NR tight interworking for the user plane (UP)

FIG. 2 is a split bearer illustration for the control plane (CP) in 5G.

FIG. 3 illustrates a measurement model.

FIG. 4 is a block diagram of a wireless device, according to some embodiments.

FIG. 5 illustrates a flow diagram of a method by the wireless device, according to some embodiments.

FIG. 6 is a block diagram of a network node, according to some embodiments.

FIG. 7 illustrates a flow diagram of a method by the network node, according to some embodiments.

FIG. 8 schematically illustrates a telecommunication network connected via an intermediate network to a host computer, according to some embodiments.

FIG. 9 is a generalized block diagram of a host computer communicating via a base station with a user equipment over a partially wireless connection, according to some embodiments.

FIGS. 10 to 13 are flowcharts illustrating example methods implemented in a communication system including a host computer, a base station and a user equipment.

FIG. 14 is a block diagram illustrating a functional implementation of a wireless device, according to some embodiments.

FIG. 15 is a block diagram illustrating a functional implementation of a network node, according to some embodiments.

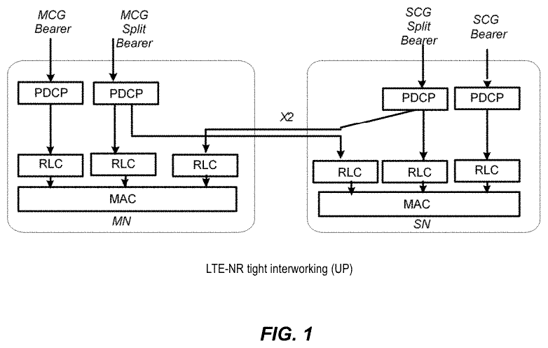

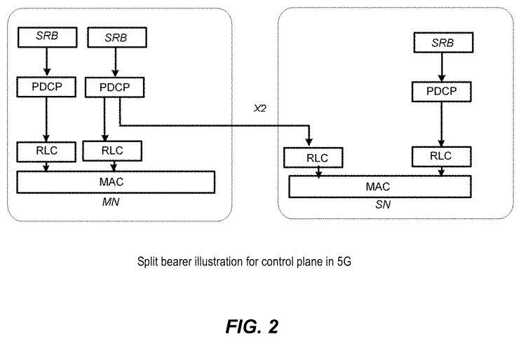

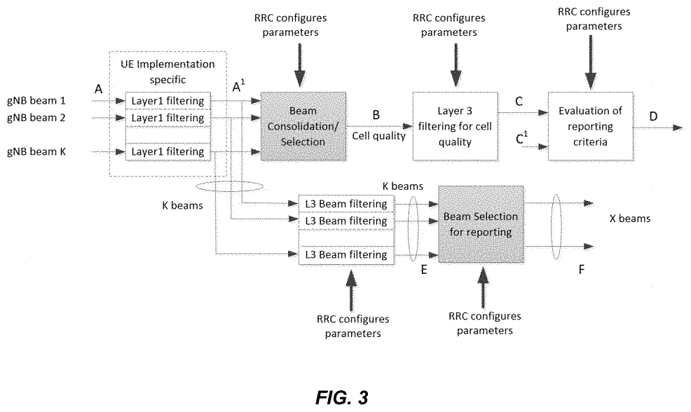

### DETAILED DESCRIPTION OF EMBODIMENTS

Exemplary embodiments of the present disclosure will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment can be tacitly assumed to be present/used in another embodiment.

The inventive techniques and apparatus described herein are explained in the context of EN-DC. However, it will be appreciated that these techniques and apparatus are more generally applicable to MR-DC scenarios, i.e., where a wireless device configured to support simultaneous connections to one or more serving cells in a first radio access network (RAN), using a first radio access technology (RAT), and to one or more serving cells in a second RAN, using a second RAT that differs from the first RAT.

In EN-DC there can be MN-centric scenarios, where SN mobility decisions can be made by the MN, or SN-centric scenarios, where SN mobility decisions are made by the SN. A combination of the two can also be envisioned.

In SN-centric scenarios, LTE MN is only interested to know the measurement results from LTE serving cell, similarly NR SN is only interested to know the measurement results from NR serving cell.

In MN-centric scenarios, on the other hand, the LTE solution of only having LTE measurements would make difficult to the MN to take NR mobility decisions. For example, for MN initiated SN change, it would be very useful for LTE MN to know the quality of NR serving cells so that LTE MN can know whether or not to change the SN.

In addition, NR defines new types of measurements that can be reported compared to LTE. Based on the NR measurement model described in the background, one can see that the UE can be configured in NR to report L3 filtered beam-specific measurement results (e.g. SS-RSRP, SS-RSRQ, SS-SINR, CSI-RSRP, CSI-RSRQ and CSI-SINR) where these are L3 filtered per reference signal index.

In the following portions of computer code, areas of emphasis are marked in bold. In the structure of reportConfig in NR, the network can configure these beam-specific measurements with the following IEs:

| | |
|---|---|
| reportQuantityRsIndexes | MeasReportQuantityIndexes, |
| maxNroRsIndexesToReport | INTEGER (1..maxNroIndexesToReport) |

ReportConfigNR information element

| | |
|---|---|
| -- ASN1START | |
| ReportConfigNR ::= | SEQUENCE { |
| reportType | CHOICE { |
| periodical | PeriodicaReportConfig, |
| eventTriggered | EventTriggerConfig |
| } | |
| } | |

-- Current structure allows easier definiton of new events and new report types e.g. CGI, etc.

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |
| }, | |
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |
| }, | |
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useWhiteCellList | BOOLEAN OPTIONAL |
| }, | |
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useWhiteCellList | BOOLEAN OPTIONAL |
| }, | |
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useWhiteCellList | BOOLEAN OPTIONAL |
| }, | |
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useWhiteCellList | BOOLEAN OPTIONAL |
| }, | |
| }, | |

--Common reporting config (at least to periodical and eventTriggered)

| | |
|---|---|
| reportInterval | ReportInterval, |
| reportAmount | ENUMERATED {FFS!}, |
| --Cell reporting configuration | |
| reportQuantityCell | MeasReportQuantity, |
| maxReportCells | INTEGER (1..maxCellReport), |

--RS index reporting configuration

| | |
|---|---|
| reportQuantityRsIndexes | MeasReportQuantityIndexes |
| OPTIONAL, | |
| maxNroIndexToReport | INTEGER (1..maxNroIndexesToReport) |
| OPTIONAL, | |

--If configured the UE includes the hest neighbour cells per serving frequency

| | |
|---|---|
| reportAddNeighMeas | TYPE_FFS! |
| } | |
| PeriodicaReportConfig::= | SEQUENCE { |

--Common reporting config (at least to periodical and eventTriggered)

| | |
|---|---|
| reportInterval | ReportInterval, |
| reportAmount | ENUMERATED {FFS!}, |
| --Cell roporting configuration | |
| reportQuantityCell | MeasReportQuantity, |
| maxReportCells | INTEGER (1..maxCellReport), |

--RS index reporting configuration

| | |
|---|---|
| reportQuantityRsIndexes | MeasReportQuantityIndexes, |
| maxNroRsIndexesToReport | INTEGER (1..maxNroIndexesToReport) |
| } | |

MeasTriggerQuantity::= CHOICE {

| | |
|---|---|
| ss-rsrp | RSRPRange, |
| ss-rsrq | RSRQRange, |
| ss-sinr | SINRRange, |
| csi-rs-rsrp | RSRPRange, |
| csi-rs-rsrq | RSRQRange, |
| csi-rs-sinr | SINRRange |
| } | |

MeasTriggerQuantityOffset::= CHOICE {

| | |
|---|---|
| ss-rsrp | INTEGER (FFS!) OPTIONAL, |
| ss-rsrq | INTEGER (FFS!) OPTIONAL, |
| ss-sinr | INTEGER (FFS!) OPTIONAL, |
| csi-rs-rsrp | INTEGER (FFS!) OPTIONAL, |
| csi-rs-rsrq | INTEGER (FFS!) OPTIONAL, |
| csi-rs-sinr | INTEGER (FFS!) OPTIONAL |
| } | |

MeasReportQuantity::= SEQUENCE {

| | |
|---|---|
| ss-rsrp | TYPE_FFS! OPTIONAL, |
| ss-rsrq | TYPE_FFS! OPTIONAL, |
| ss-sinr | TYPE_FFS! OPTIONAL, |
| csi-rs-rsrp | TYPE_FFS! OPTIONAL, |
| csi-rs-rsrq | TYPE_FFS! OPTIONAL, |
| csi-rs-sinr | TYPE_FFS! OPTIONAL |
| } | |

MeasReportQuantityIndexes::= CHOICE {

| | |
|---|---|
| ss-Indexes | TYPE_FFS!, |
| csi-Indexes | TYPE_FFS!, |
| measResultsPerIndex | MeasReportQuantity |
| } | |
| -- ASN1STOP | |

As it can be seen the network can configure the UE to report ss-indexes, ss-rsrp, ss-rsrq, ss-sinr in the case of SS/PBCH block measurement and/or csi-rs-indexes, csi-rsrp, csi-rsrq, csi-sinr in the case of CSI-RS measurements. That is reflected in the IE measResults where these are included:

MeasResults information element

| | |
|---|---|
| -- ASN1START | |
| MeasResults ::= | SEQUENCE { |
| measId | MeasId, |
| measResultServingFreqList | MeasResultServFreqList, |
| measResultNeighCells | CHOICE { |
| measResultListNR | MeasResultListNR |
| } | |
| OPTIONAL | |
| } | |

MeasResultServFreqList ::= SEQUENCE (SIZE (1..maxServCell)) OF MeasResultServFreq

| | | |
|---|---|---|
| MeasResultServFreq ::= | SEQUENCE { | |
| servFreqId | ServCellIndex | OPTIONAL, |
| measResultServingCell | MeasResultNR, | |
| measResultBestNeighServingCell | MeasResultNR | OPTIONAL |
| } | | |

| MeasResultListNR ::= | SEQUENCE (SIZE (1..maxCellReport)) OF MeasResultNR | |
|---|---|---|
| MeasResultNR ::= SEQUENCE { | | |
| physCellId | PhysCellId | OPTIONAL, |
| --FFS: Details of cgi info | | |
| cgi-Info | TYPE_FFS! | |
| measResult | SEQUENCE { | |

| | |
|---|---|
| cellResults | SEQUENCE{ |

| | |
|---|---|
| resultsSSBCell | ResultsSSECell |
| OPTIONAL, | |
| resultsCSI-RSCell | ResultsCSI-RSCell |
| OPTIONAL | |
| } | |

| | |
|---|---|
| rsIndexResults | SEQUENCE{ |

| | |
|---|---|
| resultsSSBIndexes | ResultsPerSSBIndexList |
| OPTIONAL, | |
| resultsCSI-RSIndexes | ResultsPerCSI-RSIndexList |
| OPTIONAL | |

| | |
|---|---|
| } | OPTIONAL |
| } | |
| } | |
| ResultsSSBCell ::= SEQUENCE { | |

| | | |
|---|---|---|
| ssb-Cellrsrp | RSRP-Range | OPTIONAL, |
| ssb-Cellrsrq | RSRQ-Range | OPTIONAL, |
| ssb-Cellsinr | SINR-Range | OPTIONAL |
| } | | |

ResultsCSI-RSCell ::= SEQUENCE {

| | | |
|---|---|---|
| csi-rs-Cellrsrp | RSRP-Range | OPTIONAL, |
| csi-rs-Cellrsrq | RSRQ-Range | OPTIONAL, |
| csi-rs-Cellsinr | SINR-Range | OPTIONAL |
| } | | |

ResultsPerSSBIndexList::= SEQUENCE (SIZE (1..maxNroSSBa)) OF ResultsPerSSBIndex
ResultsPerSSBIndex ::= SEQUENCE {

| ssbIndex | SSBIndex, | |
|---|---|---|
| ss-rsrp | RSRP-Range | OPTIONAL, |
| ss-rsrq | RSRQ-Range | OPTIONAL, |
| ss-sinr | SINR-Range | OPTIONAL |
| } | | |

resultsPerCSI-RSIndexList::= SEQUENCE (SIZE (1..maxNroCSI-RS)) OF ResultsPerCSI-RSIndex
ResultsPerCSI-RSIndex ::= SEQUENCE {

| csi-rsIndex | CSI-RSIndex, | |
|---|---|---|
| csi-rsrp | RSRP-Range | OPTIONAL, |
| csi-rsrq | RSRQ-Range | OPTIONAL, |
| csi-sinr | SINR-Range | OPTIONAL |
| } | | |
| -- ASN1STOP | | |

Some things that can be highlighted include: the ASN.1 structure shown has only been proposed for NR, i.e., it is NR configuring NR measurements; and the ASN.1 structure does not imply the inclusion of beam-specific measurements not even for NR serving cells, although the overall structure makes these OPTIONAL for any type of cell.

Embodiments of the present invention include a method where the UE performs and reports inter-RAT serving cell measurements. In some cases, the manner by which the UE performs these measurements and the reporting of these measurement is configurable by the network, to minimize unnecessary overhead and making the report adaptable for different network scenarios/deployments.

These serving cell measurements may be: RSRP, RSRQ, SINR per cell; or RSRP, RSRQ, SINR per beam where a beam can be indicated as a reference signal index.

Advantages include that the cost for the UE to send unnecessary measurement results can be avoided, while the network can get necessary measurement results when needed for a higher degree of flexibility on what node take SN change decisions, whether it is the MN or the SN.

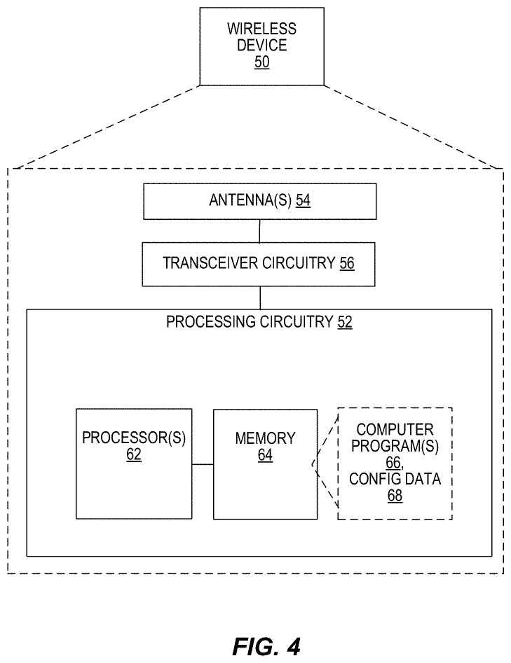

FIG. 4 illustrates a diagram of a wireless device, shown as wireless device 50, according to some embodiments. The wireless device 50 may be considered to represent any wireless terminals that may operate in a network, such as a UE in a cellular network. Other examples may include a communication device, target device, device to device (D2D) UE, machine type UE or UE capable of machine to machine communication (M2M), a sensor equipped with UE, PDA (personal digital assistant), Tablet, mobile terminal, smart phone, laptop embedded equipped (LEE), laptop mounted equipment (LME), USB dongles, Customer Premises Equipment (CPE), etc.

The wireless device 50 is configured to communicate with a radio network node or base station in a wide-area cellular network via antennas 54 and transceiver circuitry 56. The transceiver circuitry 56 may include transmitter circuits, receiver circuits, and associated control circuits that are collectively configured to transmit and receive signals according to a radio access technology, for the purposes of using cellular communication services. This radio access technologies are NR and LTE for the purposes of this discussion.

The wireless device 50 also includes one or more processing circuits 52 that are operatively associated with the radio transceiver circuitry 56. The processing circuitry 52 comprises one or more digital processing circuits, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, the processing circuitry 52 may comprise fixed circuitry, or programmable circuitry that is specially adapted via the execution of program instructions implementing the functionality taught herein, or may comprise some mix of fixed and programmed circuitry. The processing circuitry 52 may be multi-core.

The processing circuitry 52 also includes a memory 64. The memory 64, in some embodiments, stores one or more computer programs 66 and, optionally, configuration data 68. The memory 64 provides non-transitory storage for the computer program 66 and it may comprise one or more types of computer-readable media, such as disk storage, solid-state memory storage, or any mix thereof. Here, “non-transitory” means permanent, semi-permanent, or at least temporarily persistent storage and encompasses both long-term storage in non-volatile memory and storage in working memory, e.g., for program execution. By way of non-limiting example, the memory 64 comprises any one or more of SRAM, DRAM, EEPROM, and FLASH memory, which may be in the processing circuitry 52 and/or separate from processing circuitry 52. The memory 64 may also store any configuration data 68 used by the wireless device 50. The processing circuitry 52 may be configured, e.g., through the use of appropriate program code stored in memory 64, to carry out one or more of the methods and/or signaling processes detailed hereinafter.

The processing circuitry 52 of the wireless device 50 is configured, according to some embodiments, to cause the wireless device 50 to support simultaneous connections to one or more serving cells in a first RAN, using a first RAT and to one or more serving cells in a second RAN, using a second RAT that differs from the first RAT. The processing circuitry 52 is configured to receive, from a base station in the first RAN, using the first RAT, measurement configuration information, the measurement configuration information indicating whether radio measurements performed by the wireless device 50 on one or more of the serving cells in the second RAN should be reported to the first RAN, using the first RAT. The processing circuitry 52 is also configured to selectively report measurement data for radio measurements performed by the wireless device 50 on one or more of the serving cells in the second RAN to the first RAN, using the first RAT, in accordance with the measurement configuration information.

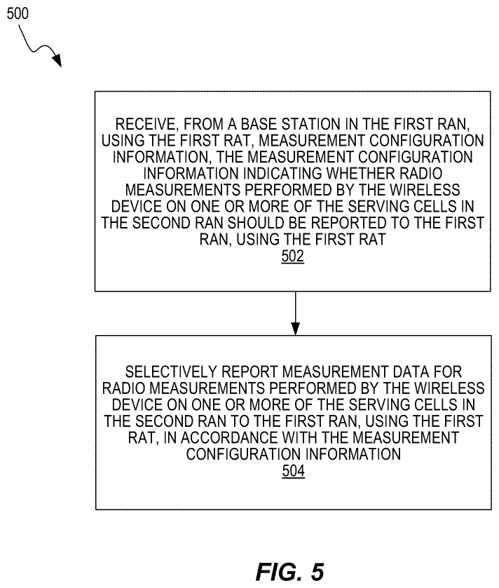

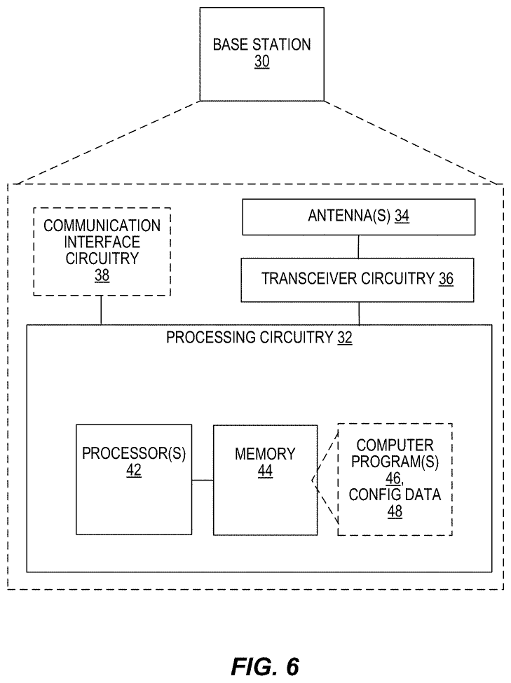

According to some embodiments, the processing circuitry 52 is configured to perform a method 500, as shown in FIG. 5. The method 500 includes receiving, from a base station in the first RAN, using the first RAT, measurement configuration information, the measurement configuration information indicating whether radio measurements performed by the wireless device on one or more of the serving cells in the second RAN should be reported to the first RAN, using the first RAT (block 502). The method 500 also includes selectively reporting measurement data for radio measurements performed by the wireless device on one or more of the serving cells in the second RAN to the first RAN, using the first RAT, in accordance with the measurement configuration information (block 504).

The base station in the first RAN may act as a master node in a multi-RAT dual-connectivity (DC) connection with the wireless device. The first RAT may be LTE (i.e., the first RAN is E-UTRAN), and the second RAT may be NR.

The measurement configuration information may further specify whether the radio measurements performed by the wireless device on one or more of the serving cells in the second RAN should include cell-based measurements or beam-based measurements, or both. The measurement configuration information may also further specify whether the radio measurements performed by the wireless device on one or more of the serving cells in the second RAN should be based on a first reference signal (RS) type or a second RS type or both first and second RS types. The first RS type may be a channel state information reference signal (CSI-RS) type and the second RS type may be a reference signal included in a synchronization signal (SS)/physical broadcast channel (PBCH) block.

The measurement configuration information may further specify reporting conditions for reporting the measurement data for the radio measurements performed by the wireless device on the one or more of the serving cells in the second RAN, where the reporting conditions comprise a periodic reporting requirement, a threshold-based reporting trigger, or both.

The measurement configuration information may further specify whether or not radio measurements performed by the wireless device on one or more of the serving cells in the first RAN should be reported to the second RAN, using the second RAT.

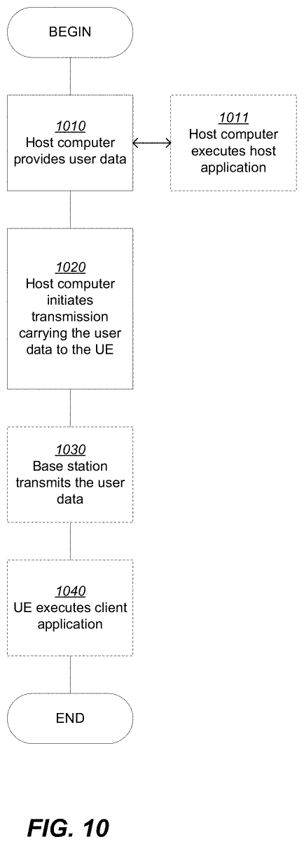

Correspondingly, FIG. 10 illustrates a diagram of the base station, shown as base station 30, that may be configured to carry out one or more of these disclosed techniques from the perspective of the base station. The base station may be an evolved Node B (eNodeB), Node B or gNB. While a base station is shown in FIG. 10, the base station operations can be performed by other kinds of network access nodes or relay nodes. In the non-limiting embodiments described below, the base station 30 will be described as being configured to operate as a cellular network access node in an LTE network or NR network.

Those skilled in the art will readily appreciate how each type of node may be adapted to carry out one or more of the methods and signaling processes described herein, e.g., through the modification of and/or addition of appropriate program instructions for execution by processing circuits 32.

The base station 30 facilitates communication between wireless terminals, other network access nodes and/or the core network. The base station 30 may include communication interface circuitry 38 that includes circuitry for communicating with other nodes in the core network, radio nodes, and/or other types of nodes in the network for the purposes of providing data and/or cellular communication services. The base station 30 communicates with wireless devices using antennas 34 and transceiver circuitry 36. The transceiver circuitry 36 may include transmitter circuits, receiver circuits, and associated control circuits that are collectively configured to transmit and receive signals according to a radio access technology, for the purposes of providing cellular communication services.

The base station 30 also includes one or more processing circuits 32 that are operatively associated with the transceiver circuitry 36 and, in some cases, the communication interface circuitry 38. The processing circuitry 32 comprises one or more digital processors 42, e.g., one or more microprocessors, microcontrollers, DSPs, FPGAs, CPLDs, ASICs, or any mix thereof. More generally, the processing circuitry 32 may comprise fixed circuitry, or programmable circuitry that is specially configured via the execution of program instructions implementing the functionality taught herein, or may comprise some mix of fixed and programmed circuitry. The processor 42 may be multi-core, i.e., having two or more processor cores utilized for enhanced performance, reduced power consumption, and more efficient simultaneous processing of multiple tasks.

The processing circuitry 32 also includes a memory 44. The memory 44, in some embodiments, stores one or more computer programs 46 and, optionally, configuration data 48. The memory 44 provides non-transitory storage for the computer program 46 and it may comprise one or more types of computer-readable media, such as disk storage, solid-state memory storage, or any mix thereof. By way of non-limiting example, the memory 44 comprises any one or more of SRAM, DRAM, EEPROM, and FLASH memory, which may be in the processing circuitry 32 and/or separate from the processing circuitry 32. The memory 44 may also store any configuration data 48 used by the network access node 30. The processing circuitry 32 may be configured, e.g., through the use of appropriate program code stored in memory 44, to carry out one or more of the methods and/or signaling processes detailed hereinafter.

The processing circuitry 32 of the base station 30 is configured, according to some embodiments, to operate as a base station in a first RAN, wherein the base station is configured to support simultaneous connections by a wireless device 50 to the base station using a first RAT and to one or more serving cells in a second RAN using a second RAT that differs from the first RAT. The processing circuitry 32 is configured to send, to the wireless device 50, using the first RAT, measurement configuration information, the measurement configuration information indicating whether radio measurements performed by the wireless device 50 on one or more of the serving cells in the second RAN should be reported to the first RAN, using the first RAT. The base station in the first RAN may act as a master node in a multi-RAT DC connection with the wireless device. The first RAT may be LTE (i.e., the first RAN is E-UTRAN), and the second RAT may be NR.

The processing circuitry 32 of the base station 30 may also be configured to perform a method 700, such as by a base station in a first RAN, where the base station is configured to support simultaneous connections by a wireless device to the base station using a first RAT and to one or more serving cells in a second RAN using a second RAT that differs from the first RAT. The method 700 includes sending, to the wireless device, using the first RAT, measurement configuration information, the measurement configuration information indicating whether radio measurements performed by the wireless device on one or more of the serving cells in the second RAN should be reported to the first RAN, using the first RAT (block 702).

Some aspects related to the embodiments include, though a focus here is on the LTE-NR tight interworking case where the LTE is the master node (referred to as EN-DC), various embodiments are also applicable to other DC cases, such as NR-LTE DC, where NR is the master and LTE is the secondary node (referred to as NE-DC). Also, LTE and NR are the RATs that are covered in this description. However, various embodiments may also be applicable to any aggregation scenario where the MN and SN apply different cellular/wireless RATs.

One aspect is that whether the UE sends one RAT serving cell measurement results to the other RAT depends on network configuration, which depends on, for example, which node is making mobility decisions. Instead of always reporting, the network can make it configurable to avoid the overhead of always reporting especially in the case the SN is taking mobility decisions.

The UE may be configured to include SN serving cells measurement information (e.g. PSCell(s) and SCell(s)) in MN configured measurement reports, such as A1-A6 or B1-B2 (i.e., not only inter-RAT events). That can be useful in MN-centric scenarios, where the MN can make SN change decisions.

SN serving cell measurement information may be related to one or a combination of the following: SN PCell (i.e. the PSCell from the MN perspective); SN SCells, i.e., each SCell configured for a given SN carrier; Best X neighbor cells in the frequency of the SN PCell; Best X neighbor cells in the frequency of a SN SCell—that may be configured for all configured SN SCells.

SN measurement information for one of the particular SN cell(s) described above, in the context of the invention, can be: measurement results such as RSRP, RSRQ, SINR or any other quality metric; measurement results associated to different RS types, e.g., SS/PBCH block(s) reference signal (such as NR secondary sync signal) or CSI-RS; measurement results associated to NR cells or beams (from NR cells); beam measurement results, which are measurement results associated to one or multiple reference signal (RS) indexes associated to NR cells; RS indexes in this context can be SS/PBCH block(s) indexes or CSI-RS resource indexes; beam indexes derived from measurement results associated to one or multiple reference signal (RS) indexes associated to NR cells; RS indexes in this context can be SS/PBCH block(s) indexes or CSI-RS resource indexes derived based on the measurements e.g. indexes associated to strongest measurement values; and/or measurement results associated to NR cells or beams (from NR cells).

In another embodiment, the different measurement information described in the previous embodiment may be configured independently. For example, the UE may be configured by the MN to perform SN cell level measurements per measurement quantity e.g. SINR, RSRP, RSRQ, RSRP and RSRQ, RSRP and SINR, SINR and RSRQ, RSRQ, RSRP and SINR. A configuration may also indicate that these shall be included in measurement reports. The network can configure the UE to report the abovementioned measurement quantities either for a particular RS type (e.g. SS/PBCH block(s) or CSI-RS) or both. The network can configure the UE to report the abovementioned measurement quantities per RS type associated to NR cells only. In another example, the network can configure the UE to report the abovementioned measurement quantities per RS type associated to NR cells and beams (RS indexes) for NR cells.

In one embodiment, the UE can be configured to include SN serving cells measurement information in inter-RAT triggered measurement report configured by MN, like B events (e.g. B1-B2).

In another embodiment, the UE can be configured to include SN serving cells measurement information in intra-RAT triggered measurement report configured by MN such as A1-A6 (intra-RAT events).

In another embodiment, the UE can be configured to include SN serving cells measurement information in periodical measurement report configured by MN.

In another embodiment, the UE can be configured to include MN serving cells measurement information in SN configured measurement reports, such as A1-A6 or B1-B2 (i.e., not only inter-RAT events). That can be useful in SN-centric scenarios, where the SN can make SN change decisions.

One way of realizing this is in reportConfigInterRAT, where a new IE, reportNRServingCell, can be included to indicate whether LTE MN wants the UE to report NR serving cell measurement results to LTE MN or not.

| | |
|---|---|
| -- ASN1START | |
| ReportConfigInterRAT ::= | SEQUENCE { |

| | |
|---|---|
| triggerType | CHOICE { |

| | |
|---|---|
| event | SEQUENCE { |

| | |
|---|---|
| eventId | CHOICE { |

| | |
|---|---|
| eventB1 | SEQUENCE { |

| | |
|---|---|
| b1-Threshold | CHOICE { |

| | |
|---|---|
| b1-ThresholdUTRA | ThresholdUTRA, |
| b1-ThresholdGERAN | ThresholdGERAN, |

| | |
|---|---|
| b1-ThresholdCDMA2000 | ThresholdCDMA2000 |

}

| | |
|---|---|
| }, | |
| eventB2 | SEQUENCE { |

| | |
|---|---|
| b2-Threshold1 | ThresholdEUTRA, |
| b2-Threshold2 | CHOICE { |

| | |
|---|---|
| b2-Threshold2UTRA | ThresholdUTRA, |
| b2-Threshold2GERAN | ThresholdGERAN, |
| b2-Threshold2CDMA2000 | ThresholdCDMA2000 |

}

| | |
|---|---|
| }, | |
| ..., | |
| eventW1-r13 | SEQUENCE { |

| | |
|---|---|
| w1-Threshold-r13 | WLAN-RSSI-Range-r13 |

| | |
|---|---|
| }, | |
| eventW2-r13 | SEQUENCE { |

| | |
|---|---|
| w2-Threshold1-r13 | WLAN-RSSI-Range-r13, |
| w2-Threshold2-r13 | WLAN-RSSI-Range-r13 |

| | |
|---|---|
| }, | |
| eventW3-r13 | SEQUENCE { |

| | |
|---|---|
| w3-Threshold-r13 | WLAN-RSSI-Range-r13 |

| | |
|---|---|
| }, | |
| eventB1-r15 | SEQUENCE { |

| | |
|---|---|
| b1-Threshold-r15 | CHOICE { |

| | |
|---|---|
| b1-ThresholdNR-r15 | ThresholdNR-r15, |

...
}

| | |
|---|---|
| } | |
| eventB2-r15 | SEQUENCE { |

| | |
|---|---|
| b2-Threshold1 | ThresholdEUTRA, |
| b2-Threshold2 | CHOICE { |

| | |
|---|---|
| b2-Threshold2NR | ThresholdNR-r15, |
| ... | |

}

},

| | |
|---|---|
| hysteresis | Hysteresis, |
| timeToTrigger | TimeToTrigger |

| | |
|---|---|
| }, | |
| periodical | SEQUENCE { |

| | |
|---|---|
| purpose | ENUMERATED { |

reportStrongestCells,
reportStrongestCellsForSON,
reportCGI}

}

| | |
|---|---|
| }, | |
| maxReportCells | INTEGER (1..maxCellReport), |
| reportInterval | ReportInterval, |
| reportAmount | ENUMERATED {r1,r2,r4,r8,r16,r32,r64, infinity}, |
| ..., | |

| | | | |
|---|---|---|---|
| [[ | si-RequestForHO-r9 | ENUMERATED {setup} | OPTIONAL-- Cond reportCGI |
| ]], | | | |

| | | | |
|---|---|---|---|
| [[ | reportQuantityUTRA-FDD-r10 | ENUMERATED {both} | OPTIONAL-- Need OR |
| ]], | | | |

| | | | | |
|---|---|---|---|---|
| [[ | includeLocationInfo-r11 | BOOLEAN | OPTIONAL | -- Need ON |
| ]], | | | | |
| [[ | b2-Threshold1-v1250 | CHOICE { | | |

| | |
|---|---|
| release | NULL, |

| | |
|---|---|
| setup | RSRQ-Range-v1250 |

| | | |
|---|---|---|
| } | OPTIONAL | -- Need ON |

| ]], | | | |
|---|---|---|---|
| [[ | reportQuantityWLAN-r13 | ReportQuantityWLAN-r13 OPTIONAL--Need ON | |
| ]], | | | |
| [[ | reportAnyWLAN-r14 | BOOLEAN | OPTIONAL--Need ON |
| ]], | | | |
| [[ | | | |

| | |
|---|---|
| reportNRServingFreqConfig | SEQUENCE { |

| reportQuantityCell | MeasReportQuantity, | |
|---|---|---|
| maxReportCells | INTEGER (1..maxCellReport), | |
| --RS index reporting configuration | | |
| reportQuantityRsIndexes | MeasReportQuantityIndexes | OPTIONAL, |
| maxNroIndexToReport | INTEGER (1..maxNroIndexesToReport) | OPTIONAL, |

--If configured the UE includes the best neighbour cells per NR serving frequency

| -- TYPE_FFS! Means that the type is still under discussion in 3gpp | |
|---|---|
| reportAddNeighMeas | TYPE_FFS! |

| | |
|---|---|
| } | OPTIONAL, |

MeasReportQuantity::= SEQUENCE {

| | | |
|---|---|---|
| ss-rsrp | TYPE_FFS! | OPTIONAL, |
| ss-rsrq | TYPE_FFS! | OPTIONAL, |
| ss-sinr | TYPE_FFS! | OPTIONAL, |
| csi-rs-rsrp | TYPE_FFS! | OPTIONAL, |
| csi-rs-rsrq | TYPE_FFS! | OPTIONAL, |
| csi-rs-sinr | TYPE_FFS! | OPTIONAL |

| | |
|---|---|
| } | |
| MeasReportQuantityIndexes::= | CHOICE { |

| | |
|---|---|
| ss-Indexes | TYPE_FFS!, |
| csi-Indexes | TYPE_FFS!, |
| measResultsPerIndex | MeasReportQuantity |

}

]]

}

If reportNRServingFreqConfig is configured, when measurement report is triggered due to eventB1, event B2, or periodic, measurement results of NR serving cell will be reported by UE to LTE MN including the configured exact measurement information.

The method can be employed also in the ReportConfigEUTRA message, as shown below, because the MN can use the provided serving cell information to perform/trigger an MN handover with SN change.

| | |
|---|---|
| -- ASN1START | |
| ReportConfigEUTRA ::= | SEQUENCE { |

| | |
|---|---|
| triggerType | CHOICE { |
| event | SEQUENCE { |

| | |
|---|---|
| eventId | CHOICE { |

| | |
|---|---|
| eventA1 | SEQUENCE { |
| a1-Threshold | ThresholdEUTRA |
| }, | |
| eventA2 | SEQUENCE { |
| a2-Threshold | ThresholdEUTRA |
| }, | |
| eventA3 SEQUENCE | { |
| a3-Offset | INTEGER (−30..30), |
| reportOnLeave | BOOLEAN |
| }, | |
| eventA4 | SEQUENCE { |
| a4-Threshold | ThresholdEUTRA |
| }, | |
| eventA5 | SEQUENCE { |
| a5-Threshold1 | ThresholdEUTRA, |
| a5-Threshold2 | ThresholdEUTRA |
| }, | |
| ..., | |
| eventA6-r10 | SEQUENCE { |
| a6-Offset-r10 | INTEGER (−30..30), |
| a6-ReportOnLeave-r10 | BOOLEAN |
| }, | |
| eventC1-r12 | SEQUENCE { |
| c1-Threshold-r12 | ThresholdEUTRA-v1250, |
| c1-ReportOnLeave-r12 | BOOLEAN |
| }, | |
| eventC2-r12 | SEQUENCE { |
| c2-RefCSI-RS-r12 | MeasCSI-RS-Id-r12, |
| c2-Offset-r12 | INTEGER (−30..30), |
| c2-ReportOnLeave-r12 | BOOLEAN |
| }, | |
| eventV1-r14 | SEQUENCE { |
| v1-Threshold-r14 | SL-CBR-r14 |
| }, | |
| eventV2-r14 | SEQUENCE { |
| v2-Threshold-r14 | SL-CBR-r14 |
| } | |
| }, | |

| | |
|---|---|
| hysteresis | Hysteresis, |
| timeToTrigger | TimeToTrigger |
| }, | |
| periodical | SEQUENCE { |

| | |
|---|---|
| purpose | ENUMERATED { |

reportStrongestCells, reportCGI}

| | |
|---|---|
| } | |
| }, | |
| triggerQuantity | ENUMERATED {rsrp, rsrq}, |
| reportQuantity | ENUMERATED {sameAsTriggerQuantity, both}, |
| maxReportCells | INTEGER (1..maxCellReport), |
| reportInterval | ReportInterval, |
| reportAmount | ENUMERATED {r1, r2, r4, r8, r16, r32, r64, infinity}, |
| ..., | |

| | | | |
|---|---|---|---|
| [[ si-RequestForHO-r9 | ENUMERATED {setup} | OPTIONAL, | -- Cond reportCGI |

| | | |
|---|---|---|
| ue-RxTxTimeDiffPeriodical-r9 | ENUMERATED {setup} | OPTIONAL-- Need OR |
| ]], | | |

| | | | |
|---|---|---|---|
| [[ includeLocationInfo-r10 | ENUMERATED {true} | OPTIONAL, | -- Need OR |

| | | |
|---|---|---|
| reportAddNeighMeas-r10 | ENUMERATED {setup} | OPTIONAL-- Need OR |
| ]], | | |

| | |
|---|---|
| [[ alternativeTimeToTrigger-r12 | CHOICE { |

| | |
|---|---|
| release | NULL, |

| setup | TimeToTrigger | | |
|---|---|---|---|
| } | | OPTIONAL, | -- Need ON |
| useT312-r12 | BOOLEAN | OPTIONAL, | -- Need ON |

| | | | |
|---|---|---|---|
| usePSCell-r12 | BOOLEAN | OPTIONAL, | --Need ON |

| | | | |
|---|---|---|---|
| aN-Threshold1-v1250 | RSRQ-RangeConfig-r12 | OPTIONAL, | -- Need ON |
| a5-Threshold2-v1250 | RSRQ-RangeConfig-r12 | OPTIONAL, | -- Need ON |

| | | | |
|---|---|---|---|
| reportStrongestCSI-RSs-r12 | BOOLEAN | OPTIONAL, | -- Need ON |

| | | | |
|---|---|---|---|
| reportCRS-Meas-r12 | BOOLEAN | OPTIONAL, | -- Need ON |

| | | | |
|---|---|---|---|
| triggerQuantityCS1-RS-r12 | BOOLEAN | OPTIONAL | -- Need ON |
| ]], | | | |

| | | | |
|---|---|---|---|
| [[ reportSSTD-Meas-r13 | BOOLEAN | OPTIONAL, | -- Need ON |
| rs-sinr-Config-r13 | CHOICE { | | |

| | |
|---|---|
| release | NULL, |

| | |
|---|---|
| setup | SEQUENCE { |

| | | | |
|---|---|---|---|
| triggerQuantity-v1310 | ENUMERATED {sinr} | OPTIONAL, | -- Need ON |
| aN-Threshold1-r13 | RS-SINR-Range-r13 | OPTIONAL, | -- Need ON |
| a5-Threshold2-r13 | RS-SINR-Range-r13 | OPTIONAL, | -- Need ON |

| | |
|---|---|
| reportQuantity-v1310 | ENUMERATED {rsrpANDsinr,rsrqANDsinr, all} |
| } | |

| | | |
|---|---|---|
| } | OPTIONAL, | -- Need ON |

| | | | |
|---|---|---|---|
| useWhiteCellList-r13 | BOOLEAN | OPTIONAL, | -- Need ON |

| | | | |
|---|---|---|---|
| measRSSI-ReportConfig-r13 | MeasRSSI-ReportConfig-r13 | OPTIONAL, | -- Need ON |

| | | | |
|---|---|---|---|
| includeMultiBandInfo-r13 | ENUMERATED {true} | OPTIONAL, | -- Cond reportCGI |

| | | |
|---|---|---|
| ul-DelayConfig-r13 | UL-DelayConfig-r13 | OPTIONAL-- Need ON |
| ]], | | |

| | | |
|---|---|---|
| [[ ue-RxTxTimeDiffPeriodicalTDD-r13 | BOOLEAN | OPTIONAL -- Need ON |
| ]], | | |
| [[ | | |

purpose-v14xy ENUMERATED {reportLocation, spare3, spare2, spare1}

OPTIONAL -- Need ON

```
    ]],
    [[
```

| | |
|---|---|
| reportNRServingFreqConfig | SEQUENCE { |

| | |
|---|---|
| reportQuantityCell | MeasReportQuantity, |
| maxReportCells | INTEGER (1..maxCellReport), |

--RS index reporting configuration

| | | |
|---|---|---|
| reportQuantityRsIndexes | MeasReportQuantityIndexes | OPTIONAL, |
| maxNroIndexToReport | INTEGER (1..maxNroIndexesToReport) | OPTIONAL, |

```
            --If configured the UE includes the best neighbour cells per NR serving frequency
            -- TYPE_FFS! Means that the type is still under discussion in 3gpp
```

| | |
|---|---|
| reportAddNeighMeas | TYPE_FFS! |

| | |
|---|---|
| } | OPTIONAL, |

MeasReportQuantity::= SEQUENCE {

| | | |
|---|---|---|
| ss-rsrp | TYPE_FFS! | OPTIONAL, |
| ss-rsrq | TYPE_FFS! | OPTIONAL, |
| ss-sinr | TYPE_FFS! | OPTIONAL, |
| csi-rs-rsrp | TYPE_FFS! | OPTIONAL, |
| csi-rs-rsrq | TYPE_FFS! | OPTIONAL, |
| csi-rs-sinr | TYPE_FFS! | OPTIONAL |
| } | | |

| | |
|---|---|
| MeasReportQuantityIndexes::= | CHOICE { |

| | |
|---|---|
| ss-Indexes | TYPE_FFS!, |
| csi-Indexes | TYPE_FFS!, |
| measResultsPerIndex | MeasReportQuantity |
| } | |
| ]] | |
| } | |

Note that the configuration above could be applicable for a subset of configurable events, e.g., only A3 events, i.e., in that case the network could only configure these information for be reported if A3 event is configured. Alternatively, that could be applicable for any event.

The reportNRServingFreqConfig IE can also be included instead (or additionally) in other RRC reconfiguration messages. For example, in one embodiment, a new RRC message can be introduced that can be used to change the behaviour of the reporting of the SN serving cells to the MN. This message could include the reportNRServingFreqConfig and any additional information (e.g., whether it is applicable to all measurement reports being sent to the MN, whether it is applicable to inter-RAT measurement reports being sent to the MN, etc.). Also, it can contain a set of multiple reportNRServingFreqConfig for the inter-RAT and intra-RAT measurement reports, where the level of details of the included information in the two cases could differ (e.g., report only SN serving cells cell level results for intra-RAT measurement reports, while include also beam level results of the SN serving cells for the inter-RAT measurement reports, etc.).

There are different ways to report NR serving measurement result to LTE MN. One embodiment is that NR serving measurement results are formatted in LTE RRC and included in measResult of LTE. A new IE measResultServFreqListNR-r15 is defined in it as below which is used to convey NR serving cell measurement results.

| | |
|---|---|
| MeasResults ::= | SEQUENCE { |

| | |
|---|---|
| measId | MeasId, |

| | |
|---|---|
| measResultPCell | SEQUENCE { |

| | |
|---|---|
| rsrpResult | RSRP-Range, |
| rsrqResult | RSRQ-Range |
| }, | |

| | |
|---|---|
| measResultNeighCells | CHOICE { |

| | |
|---|---|
| measResultListEUTRA | MeasResultListEUTRA, |
| measResultListUTRA | MeasResultListUTRA, |

| | |
|---|---|
| measResultListGERAN | MeasResultListGERAN, |
| measResultsCDMA2000 | MeasResultsCDMA2000, |
| ..., | |
| measResultListNR | MeasResultListNR |

| | |
|---|---|
| } | OPTIONAL, |
| ..., | |

| | | |
|---|---|---|
| [[ measResultForECID-r9 | MeasResultForECID-r9 | OPTIONAL |
| ]], | | |

| | | |
|---|---|---|
| [[ locationInfo-r10 | LocationInfo-r10 | OPTIONAL, |

| | | |
|---|---|---|
| measResultServFreqList-r10 | MeasResultServFreqList-r10 | OPTIONAL |
| ]], | | |
| [[ measId-v1250 | MeasId-v1250 | OPTIONAL, |
| measResultPCell-v1250 | RSRQ-Range-v1250 | OPTIONAL, |

| | | |
|---|---|---|
| measResultCSI-RS-List-r12 | MeasResultCSI-RS-List-r12 | OPTIONAL |
| ]], | | |

| | | |
|---|---|---|
| [[ measResultForRSSI-r13 | MeasResultForRSSI-r13 | OPTIONAL, |

| | | |
|---|---|---|
| measResultServFreqListExt-r13 | MeasResultServFreqListExt-r13 | OPTIONAL, |

| | | |
|---|---|---|
| measResultSSTD-r13 | MeasResultSSTD-r13 | OPTIONAL, |
| measResultPCell-v1310 | SEQUENCE { | |

| | |
|---|---|
| rs-sinr-Result-r13 | RS-SINR-Range-r13 |

| | |
|---|---|
| } | OPTIONAL, |

| | | |
|---|---|---|
| ul-PDCP-DelayResultList-r13 | UL-PDCP-DelayResultList-r13 | OPTIONAL, |
| measResultListWLAN-r13 | MeasResultListWLAN-r13 | OPTIONAL |
| ]], | | |

| | | |
|---|---|---|
| [[ measResultListCBR-r14 | MeasResultListCBR-r14 | OPTIONAL, |

| | | |
|---|---|---|
| measResultListWLAN-r14 | MeasResultListWLAN-r14 | OPTIONAL |
| ]] | | |
| [[ | | |
| measResultServFreqListNR-r15 | MeasResultServFreqListNR-r15 | OPTIONAL |
| ]] | | |
| } | | |

MeasResultServFreqList-r15 ::= SEQUENCE (SIZE (1..maxServCell-r10)) OF MeasResultServFreqNR-r15

| | |
|---|---|
| MeasResultServFreqNR-r15::= | SEQUENCE { |

--It may also contain SSB frequency location information

| carrierFreq-r15 | ARFCN-ValueNR, | |
|---|---|---|
| measResultServingCell | MeasResultNR, | |
| measResultBestNeighServingCell | MeasResultNR | OPTIONAL |
| } | | |
| MeasResultNR ::= SEQUENCE { | | |

| | | |
|---|---|---|
| physCellId | PhysCellId | OPTIONAL, |
| --FFS: Details of cgi info | | |
| cgi-Info | TYPE_FFS! | |

| | |
|---|---|
| measResult | SEQUENCE { |

| | |
|---|---|
| cellResults | SEQUENCE{ |

| | | |
|---|---|---|
| resultsSSBCell | ResultsSSBCell | OPTIONAL, |
| resultsCSI-RSCell | ResultsCSI-RSCell | OPTIONAL |
| } | | |

| | |
|---|---|
| rsIndexResults | SEQUENCE{ |

| | | |
|---|---|---|
| resultsSSBIndexes | ResultsPerSSBIndexList | OPTIONAL, |
| resultsCSI-RSIndexes | ResultsPerCSI-RSIndexList | OPTIONAL |

| | |
|---|---|
| } | OPTIONAL |
| } | |
| } | |
| ResultsSSBCell ::= SEQUENCE { | |

| | | |
|---|---|---|
| ssb-Cellrsrp | RSRP-Range | OPTIONAL, |
| ssb-Cellrsrq | RSRQ-Range | OPTIONAL, |
| ssb-Cellsinr | SINR-Range | OPTIONAL |
| } | | |

ResultsCSI-RSCell ::= SEQUENCE {

| | | |
|---|---|---|
| csi-rs-Cellrsrp | RSRP-Range | OPTIONAL, |
| csi-rs-Cellrsrq | RSRQ-Range | OPTIONAL, |
| csi-rs-Cellsinr | SINR-Range | OPTIONAL |
| } | | |

ResultsPerSSBIndexList::= SEQUENCE (SIZE (1..maxNroSSBs)) OF ResultsPerSSBIndex
ResultsPerSSBIndex ::= SEQUENCE {

| | |
|---|---|
| ssbIndex | SSBIndex, |

| | | |
|---|---|---|
| ss-rsrp | RSRP-Range | OPTIONAL, |
| ss-rsrq | RSRQ-Range | OPTIONAL, |
| ss-sinr | SINR-Range | OPTIONAL |
| } | | |

resultsPerCSI-RSIndexList::= SEQUENCE (SIZE (1..maxNroCSI-RS)) OF ResultsPerCSI-RSIndex
ResultsPerCSI-RSIndex ::= SEQUENCE {

| | | |
|---|---|---|
| csi-rsIndex | CSI-RSIndex, | |
| csi-rsrp | RSRP-Range | OPTIONAL, |
| csi-rsrq | RSRQ-Range | OPTIONAL, |
| csi-sinr | SINR-Range | OPTIONAL |
| } | | |
| } | | |

Another embodiment may include formatting NR serving cell measurement results in NR RRC and in a transparent container.

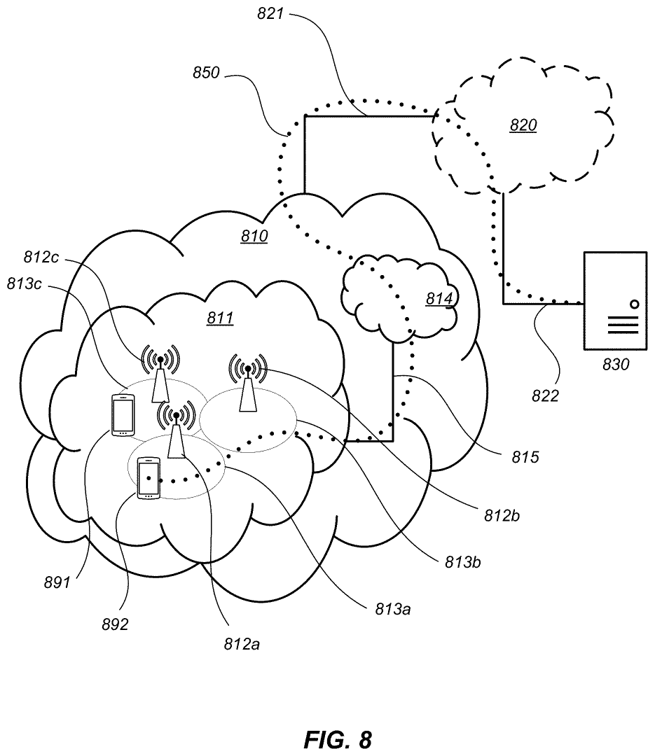

FIG. 8, according to some embodiments, illustrates a communication system that includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first user equipment (UE) 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. The connections 821, 822 between the telecommunication network 810 and the host computer 830 may extend directly from the core network 814 to the host computer 830 or may go via an optional intermediate network 820. The intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between one of the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, a base station 812 may not or need not be informed about the past routing of an incoming downlink communication with data originating from a host computer 830 to be forwarded (e.g., handed over) to a connected UE 891. Similarly, the base station 812 need not be aware of the future routing of an outgoing uplink communication originating from the UE 891 towards the host computer 830.

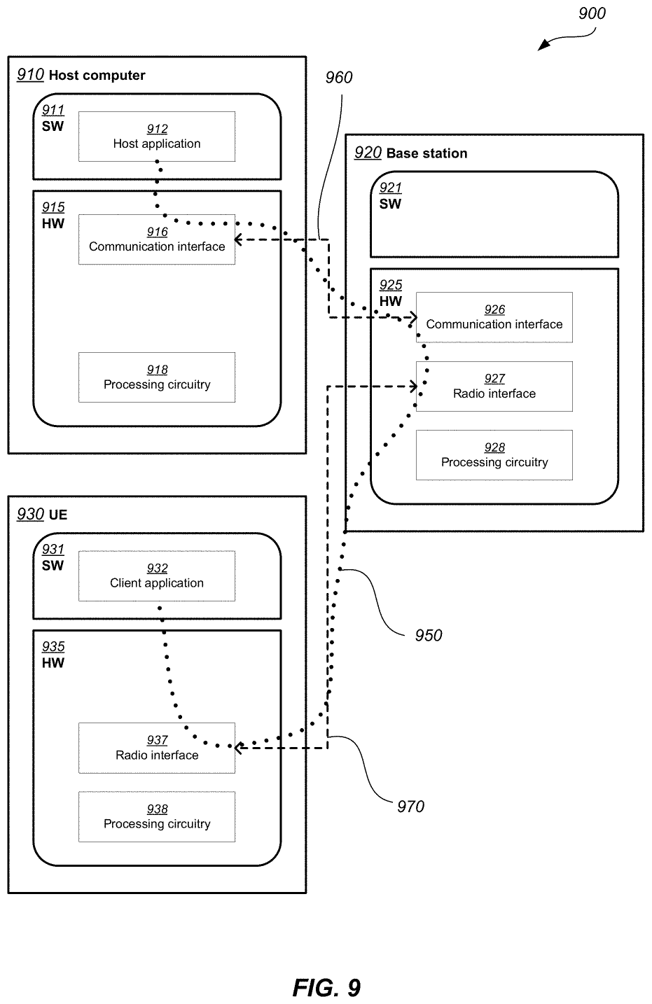

Example implementations, in accordance with an embodiment, of the UE, base station and host computer discussed in the preceding paragraphs will now be described with reference to FIG. 9. In a communication system 900, a host computer 910 comprises hardware 915 including a communication interface 916 configured to set up and maintain a wired or wireless connection with an interface of a different communication device of the communication system 900. The host computer 910 further comprises processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as a UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with a UE 930 located in a coverage area (not shown in FIG. 9) served by the base station 920. The communication interface 926 may be configured to facilitate a connection 960 to the host computer 910. The connection 960 may be direct or it may pass through a core network (not shown in FIG. 9) of the telecommunication system and/or through one or more intermediate networks outside the telecommunication system. In the embodiment shown, the hardware 925 of the base station 920 further includes processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, base station 920 and UE 930 illustrated in FIG. 9 may be identical to the host computer 830, one of the base stations 812a, 812b, 812c and one of the UEs 891, 892 of FIG. 8, respectively. This is to say, the inner workings of these entities may be as shown in FIG. 9 and independently, the surrounding network topology may be that of FIG. 8.

In FIG. 9, the OTT connection 950 has been drawn abstractly to illustrate the communication between the host computer 910 and the use equipment 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

The wireless connection 970 between the UE 930 and the base station 920 is in accordance with the teachings of the embodiments described throughout this disclosure, such as provided for wireless device 50 and base station 30, along with the corresponding methods 500 and 700. The various embodiments described herein allow for the cost for the UE 930 to send unnecessary measurement results to be avoided, while the network can get necessary measurement results when needed for a higher degree of flexibility on what node take SN change decisions, whether it is the MN or the SN. This, in turn, improves the performance of OTT services provided to the UE 930 using the OTT connection 950, in which the wireless connection 970 forms the last segment. More precisely, the teachings of these embodiments may improve the data rate, capacity, latency and/or power consumption for the network and UE 930 using the OTT connection 950 and thereby provide benefits such as reduced user waiting time, relaxed restriction on file size, more capacity, better responsiveness, and better device battery time.

A measurement procedure may be provided for the purpose of monitoring data rate, latency and other factors on which the one or more embodiments improve. There may further be an optional network functionality for reconfiguring the OTT connection 950 between the host computer 910 and UE 930, in response to variations in the measurement results. The measurement procedure and/or the network functionality for reconfiguring the OTT connection 950 may be implemented in the software 911 of the host computer 910 or in the software 931 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer's 910 measurements of throughput, propagation times, latency and the like. The measurements may be implemented in that the software 911, 931 causes messages to be transmitted, in particular empty or ‘dummy’ messages, using the OTT connection 950 while it monitors propagation times, errors etc.

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 1010 of the method, the host computer provides user data. In an optional substep 1011 of the first step 1010, the host computer provides the user data by executing a host application. In a second step 1020, the host computer initiates a transmission carrying the user data to the UE. In an optional third step 1030, the base station transmits to the UE the user data which was carried in the transmission that the host computer initiated, in accordance with the teachings of the embodiments described throughout this disclosure. In an optional fourth step 1040, the UE executes a client application associated with the host application executed by the host computer.

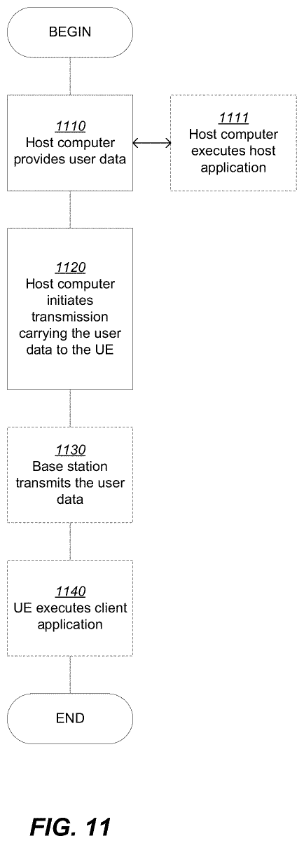

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 1110 of the method, the host computer provides user data. In an optional substep (not shown) the host computer provides the user data by executing a host application. In a second step 1120, the host computer initiates a transmission carrying the user data to the UE. The transmission may pass via the base station, in accordance with the teachings of the embodiments described throughout this disclosure. In an optional third step 1130, the UE receives the user data carried in the transmission.

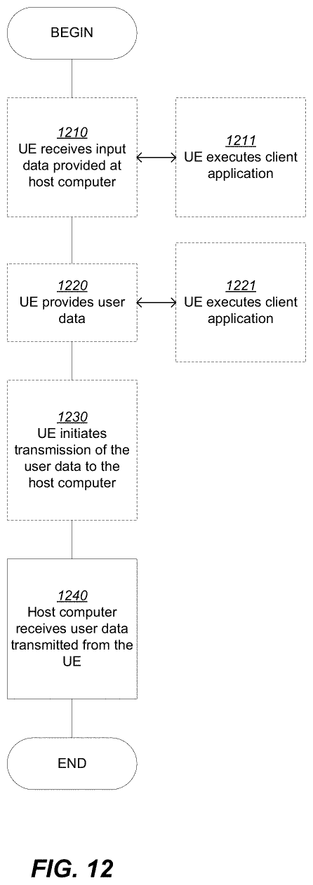

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 1210 of the method, the UE receives input data provided by the host computer. Additionally or alternatively, in an optional second step 1220, the UE provides user data. In an optional substep 1221 of the second step 1220, the UE provides the user data by executing a client application. In a further optional substep 1211 of the first step 1210, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1230, transmission of the user data to the host computer. In a fourth step 1240 of the method, the host computer receives the user data transmitted from the UE, in accordance with the teachings of the embodiments described throughout this disclosure.

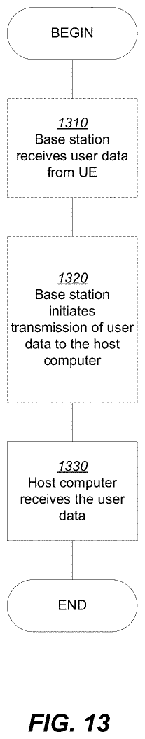

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 1310 of the method, in accordance with the teachings of the embodiments described throughout this disclosure, the base station receives user data from the UE. In an optional second step 1320, the base station initiates transmission of the received user data to the host computer. In a third step 1330, the host computer receives the user data carried in the transmission initiated by the base station.

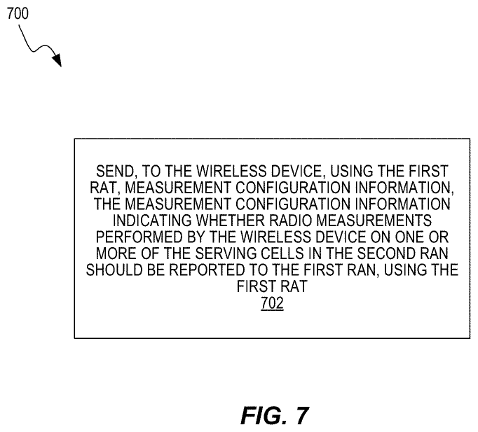

As discussed in detail above, the techniques described herein, e.g., as illustrated in the process flow diagrams of FIGS. 5 and 7, may be implemented, in whole or in part, using computer program instructions executed by one or more processors. It will be appreciated that a functional implementation of these techniques may be represented in terms of functional modules, where each functional module corresponds to a functional unit of software executing in an appropriate processor or to a functional digital hardware circuit, or some combination of both.

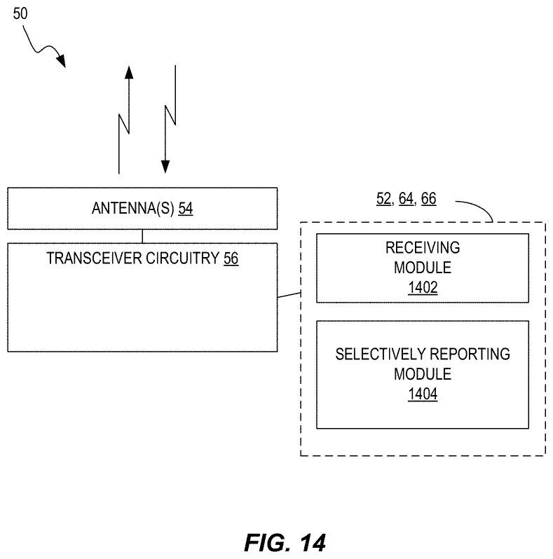

FIG. 14 illustrates an example functional module or circuit architecture as may be implemented in a wireless device, such as in wireless device 50. The functional implementation includes a receiving module 1402 for receiving, from a base station in the first RAN, using the first RAT, measurement configuration information, the measurement configuration information indicating whether radio measurements performed by the wireless device on one or more of the serving cells in the second RAN should be reported to the first RAN, using the first RAT. The implementation also includes a selectively reporting module 1404 for selectively reporting measurement data for radio measurements performed by the wireless device on one or more of the serving cells in the second RAN to the first RAN, using the first RAT, in accordance with the measurement configuration information.

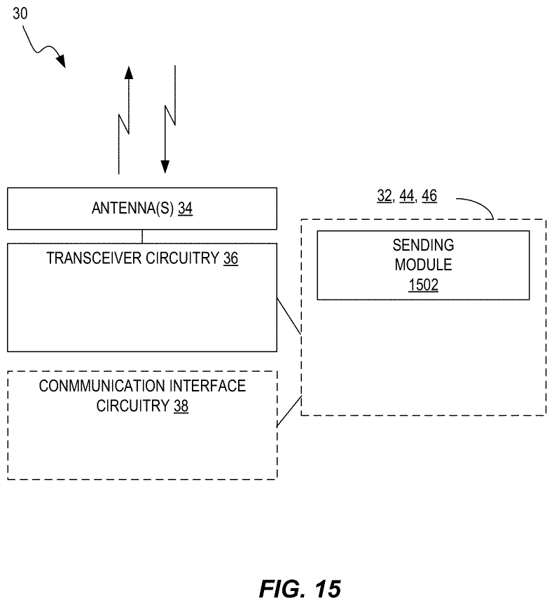

FIG. 15 illustrates an example functional module or circuit architecture as may be implemented in a base station, such as in base station 30. The functional implementation includes a sending module 1502 for sending, to the wireless device, using the first RAT, measurement configuration information, the measurement configuration information indicating whether radio measurements performed by the wireless device on one or more of the serving cells in the second RAN should be reported to the first RAN, using the first RAT.

### Example Embodiments

Example embodiments can include, but are not limited to, the following enumerated examples:

1. A method, in a wireless device configured to support simultaneous connections to one or more serving cells in a first radio access network (RAN), using a first radio access technology (RAT), and to one or more serving cells in a second RAN, using a second RAT that differs from the first RAT, the method comprising:
receiving, from a base station in the first RAN, using the first RAT, measurement configuration information, the measurement configuration information indicating whether radio measurements performed by the wireless device on one or more of the serving cells in the second RAN should be reported to the first RAN, using the first RAT; and
selectively reporting measurement data for radio measurements performed by the wireless device on one or more of the serving cells in the second RAN to the first RAN, using the first RAT, in accordance with the measurement configuration information.

2. The method of example embodiment 1, wherein the base station in the first RAN is acting as a master node in a multi-RAT dual-connectivity (DC) connection with the wireless device.

3. The method of example embodiment 1 or 2, wherein the first RAT is Long Term Evolution (LTE), i.e., the first RAN is E-UTRAN, and the second RAT is NR.

4. The method of any of example embodiments 1-3, wherein the measurement configuration information further specifies whether the radio measurements performed by the wireless device on one or more of the serving cells in the second RAN should include cell-based measurements or beam-based measurements, or both.

5. The method of any of example embodiments 1-4, wherein the measurement configuration information further specifies whether the radio measurements performed by the wireless device on one or more of the serving cells in the second RAN should be based on a first reference signal (RS) type or a second RS type or both first and second RS types.

6. The method of example embodiment 5, wherein the first RS type is a channel state information reference signal (CSI-RS) type and the second RS type is a reference signal included in a synchronization signal (SS)/physical broadcast channel (PBCH) block.

7. The method of any of example embodiments 1-6, wherein the measurement configuration information further specifies reporting conditions for reporting the measurement data for the radio measurements performed by the wireless device on the one or more of the serving cells in the second RAN, wherein the reporting conditions comprise a periodic reporting requirement, a threshold-based reporting trigger, or both.

8. The method of any of example embodiments 1-7, wherein the measurement configuration information further specifies whether or not radio measurements performed by the wireless device on one or more of the serving cells in the first RAN should be reported to the second RAN, using the second RAT.

9. A method, in a base station in a first radio access network (RAN), wherein the base station is configured to support simultaneous connections by a wireless device to the base station using a first radio access technology (RAT) and to one or more serving cells in a second RAN using a second RAT that differs from the first RAT, the method comprising:
sending, to the wireless device, using the first RAT, measurement configuration information, the measurement configuration information indicating whether radio measurements performed by the wireless device on one or more of the serving cells in the second RAN should be reported to the first RAN, using the first RAT.

10. The method of example embodiment 9, wherein the measurement configuration information indicates that radio measurements performed by the wireless device on one or more of the serving cells in the second RAN should be reported to the first RAN, using the first RAT, the method further comprising receiving, from the wireless device, measurement data for radio measurements performed by the wireless device on one or more of the serving cells in the second RAN.

11. The method of example embodiment 9 or 10, wherein the base station in the first RAN is acting as a master node in a multi-RAT dual-connectivity (DC) connection with the wireless device.

12. The method of any of example embodiments 9-11, wherein the first RAT is Long Term Evolution (LTE), i.e., the first RAN is E-UTRAN, and the second RAT is NR.

13. The method of any of example embodiments 9-12, wherein the measurement configuration information further specifies whether the radio measurements performed by the wireless device on one or more of the serving cells in the second RAN should include cell-based measurements or beam-based measurements, or both.

14. The method of any of example embodiments 9-13, wherein the measurement configuration information further specifies whether the radio measurements performed by the wireless device on one or more of the serving cells in the second RAN should be based on a first reference signal (RS) type or a second RS type or both first and second RS types.

15. The method of example embodiment 14, wherein the first RS type is a channel state information reference signal (CSI-RS) type and the second RS type is a reference signal included in a synchronization signal (SS)/physical broadcast channel (PBCH) block.

16. The method of any of example embodiments 9-15, wherein the measurement configuration information further specifies reporting conditions for reporting the measurement data for the radio measurements performed by the wireless device on the one or more of the serving cells in the second RAN, wherein the reporting conditions comprise a periodic reporting requirement, a threshold-based reporting trigger, or both.

17. The method of any of example embodiments 9-16, wherein the measurement configuration information further specifies whether or not radio measurements performed by the wireless device on one or more of the serving cells in the first RAN should be reported to the second RAN, using the second RAT.

18. A wireless device configured to support simultaneous connections to one or more serving cells in a first radio access network (RAN), using a first radio access technology (RAT) and to one or more serving cells in a second RAN, using a second RAT that differs from the first RAT, the wireless device comprising:
transceiver circuitry configured for communicating with the serving cells in the first and second RANs; and
processing circuitry operatively associated with the transceiver circuitry and configured to:
receive, from a base station in the first RAN, using the first RAT, measurement configuration information, the measurement configuration information indicating whether radio measurements performed by the wireless device on one or more of the serving cells in the second RAN should be reported to the first RAN, using the first RAT; and
   selectively report measurement data for radio measurements performed by the wireless device on one or more of the serving cells in the second RAN to the first RAN, using the first RAT, in accordance with the measurement configuration information.

19. The wireless device of example embodiment 18, wherein the base station in the first RAN is acting as a master node in a multi-RAT dual-connectivity (DC) connection with the wireless device.

20. The wireless device of example embodiment 18 or 19, wherein the first RAT is Long Term Evolution (LTE), i.e., the first RAN is E-UTRAN, and the second RAT is NR.

21. The wireless device of any of example embodiments 18-20, wherein the measurement configuration information further specifies whether the radio measurements performed by the wireless device on one or more of the serving cells in the second RAN should include cell-based measurements or beam-based measurements, or both.

22. The wireless device of any of example embodiments 18-21, wherein the measurement configuration information further specifies whether the radio measurements performed by the wireless device on one or more of the serving cells in the second RAN should be based on a first reference signal (RS) type or a second RS type or both first and second RS types.

23. The wireless device of example embodiment 22, wherein the first RS type is a channel state information reference signal (CSI-RS) type and the second RS type is a reference signal included in a synchronization signal (SS)/physical broadcast channel (PBCH) block.

24. The wireless device of any of example embodiments 18-23, wherein the measurement configuration information further specifies reporting conditions for reporting the measurement data for the radio measurements performed by the wireless device on the one or more of the serving cells in the second RAN, wherein the reporting conditions comprise a periodic reporting requirement, a threshold-based reporting trigger, or both.

25. The wireless device of any of example embodiments 18-24, wherein the measurement configuration information further specifies whether or not radio measurements performed by the wireless device on one or more of the serving cells in the first RAN should be reported to the second RAN, using the second RAT.

26. A base station in a first radio access network (RAN), wherein the base station is configured to support simultaneous connections by a wireless device to the base station using a first radio access technology (RAT) and to one or more serving cells in a second RAN using a second RAT that differs from the first RAT, the base station comprising:
transceiver circuitry configured for communicating with the serving cells in the first and second RANs; and
processing circuitry operatively associated with the transceiver circuitry and configured to:
   send, to the wireless device, using the first RAT, measurement configuration information, the measurement configuration information indicating whether radio measurements performed by the wireless device on one or more of the serving cells in the second RAN should be reported to the first RAN, using the first RAT.

27. The base station of example embodiment 26, wherein the measurement configuration information indicates that radio measurements performed by the wireless device on one or more of the serving cells in the second RAN should be reported to the first RAN, using the first RAT, the method further comprising receiving, from the wireless device, measurement data for radio measurements performed by the wireless device on one or more of the serving cells in the second RAN.

28. The base station of example embodiment 26 or 27, wherein the base station in the first RAN is acting as a master node in a multi-RAT dual-connectivity (DC) connection with the wireless device.

29. The base station of any of example embodiments 26-28, wherein the first RAT is Long Term Evolution (LTE), i.e., the first RAN is E-UTRAN, and the second RAT is NR.

30. The base station of any of example embodiments 26-29, wherein the measurement configuration information further specifies whether the radio measurements performed by the wireless device on one or more of the serving cells in the second RAN should include cell-based measurements or beam-based measurements, or both.

31. The base station of any of example embodiments 26-30, wherein the measurement configuration information further specifies whether the radio measurements performed by the wireless device on one or more of the serving cells in the second RAN should be based on a first reference signal (RS) type or a second RS type or both first and second RS types.

32. The base station of example embodiment 31, wherein the first RS type is a channel state information reference signal (CSI-RS) type and the second RS type is a reference signal included in a synchronization signal (SS)/physical broadcast channel (PBCH) block.

33. The base station of any of example embodiments 26-32, wherein the measurement configuration information further specifies reporting conditions for reporting the measurement data for the radio measurements performed by the wireless device on the one or more of the serving cells in the second RAN, wherein the reporting conditions comprise a periodic reporting requirement, a threshold-based reporting trigger, or both.

34. The base station of any of example embodiments 26-33, wherein the measurement configuration information further specifies whether or not radio measurements performed by the wireless device on one or more of the serving cells in the first RAN should be reported to the second RAN, using the second RAT.

35. A non-transitory, computer-readable medium storing computer-executable instructions that, when executed by a processing circuit of a wireless device configured to support simultaneous connections to one or more serving cells in a first radio access network (RAN), using a first radio access technology (RAT) and to one or more serving cells in a second RAN, using a second RAT that differs from the first RAT, cause the wireless device to:
receive, from a base station in the first RAN, using the first RAT, measurement configuration information, the measurement configuration information indicating whether radio measurements performed by the wireless device on one or more of the serving cells in the second RAN should be reported to the first RAN, using the first RAT; and
selectively report measurement data for radio measurements performed by the wireless device on one or more of the serving cells in the second RAN to the first RAN, using the first RAT, in accordance with the measurement configuration information.

36. A non-transitory, computer-readable medium storing computer-executable instructions that, when executed by a processing circuit of a a base station in a first radio access network (RAN), wherein the base station is configured to support simultaneous connections by a wireless device to the base station using a first radio access technology (RAT) and to one or more serving cells in a second RAN using a second RAT that differs from the first RAT, cause the base station to:
send, to the wireless device, using the first RAT, measurement configuration information, the measurement configuration information indicating whether radio measurements performed by the wireless device on one or more of the serving cells in the second RAN should be reported to the first RAN, using the first RAT.

37. A wireless device adapted to perform a method of any of example embodiments 1 to 8.

38. A network node adapted to perform a method of any of example embodiments 9 to 17.

39. A computer program product, comprising instructions that, when executed on at least one processing circuit, cause the at least one processing circuit to carry out a method according to any one of example embodiments 1 to 17.

40. A carrier containing the computer program product of example embodiment 39, wherein the carrier is one of an electronic signal, optical signal, radio signal, or computer readable storage medium.

41. A communication system including a host computer comprising:
processing circuitry configured to provide user data; and
   a communication interface configured to forward the user data to a cellular network for transmission to a user equipment (UE),
wherein the cellular network comprises a base station in a first radio access network (RAN), wherein the base station is configured to support simultaneous connections by a UE to the base station using a first radio access technology (RAT) and to one or more serving cells in a second RAN using a second RAT that differs from the first RAT, the base station having a radio interface and processing circuitry, the base station's processing circuitry configured to send, to the UE, using the first RAT, measurement configuration information, the measurement configuration information indicating whether radio measurements performed by the UE on one or more of the serving cells in the second RAN should be reported to the first RAN, using the first RAT.

42. The communication system of example embodiment 41, further including the base station.

43. The communication system of example embodiment 42, further including the UE, wherein the UE is configured to communicate with the base station.

44. The communication system of example embodiment 43, wherein:
the processing circuitry of the host computer is configured to execute a host application, thereby providing the user data; and
the UE comprises processing circuitry configured to execute a client application associated with the host application.

45. A method implemented in a communication system including a host computer, a base station and a user equipment (UE), the base station being in a first radio access network (RAN), wherein the base station is configured to support simultaneous connections by a UE to the base station using a first radio access technology (RAT) and to one or more serving cells in a second RAN using a second RAT that differs from the first RAT, the method comprising:
at the host computer, providing user data; and
at the host computer, initiating a transmission carrying the user data to the UE via a cellular network comprising the base station, wherein the method comprises, at the base station:
   sending, to the UE, using the first RAT, measurement configuration information, the measurement configuration information indicating whether radio measurements performed by the UE on one or more of the serving cells in the second RAN should be reported to the first RAN, using the first RAT.

46. The method of example embodiment 45, further comprising:
at the base station, transmitting the user data.

47. The method of example embodiment 46, wherein the user data is provided at the host computer by executing a host application, the method further comprising:
at the UE, executing a client application associated with the host application.

48. A communication system including a host computer comprising:
processing circuitry configured to provide user data; and
a communication interface configured to forward user data to a cellular network for transmission to a user equipment (UE) configured to support simultaneous connections to one or more serving cells in a first radio access network (RAN), using a first radio access technology (RAT) and to one or more serving cells in a second RAN,
wherein the UE comprises a radio interface and processing circuitry, the UE's processing circuitry configured to:
   receive, from a base station in the first RAN, using the first RAT, measurement configuration information, the measurement configuration information indicating whether radio measurements performed by the UE on one or more of the serving cells in the second RAN should be reported to the first RAN, using the first RAT; and
   selectively report measurement data for radio measurements performed by the UE on one or more of the serving cells in the second RAN to the first RAN, using the first RAT, in accordance with the measurement configuration information.

49. The communication system of example embodiment 48, further including the UE.

50. The communication system of example embodiment 49, wherein the cellular network further includes a base station configured to communicate with the UE.

51. The communication system of example embodiment 49 or 50, wherein:
the processing circuitry of the host computer is configured to execute a host application, thereby providing the user data; and
the UE's processing circuitry is configured to execute a client application associated with the host application.

52. A method implemented in a communication system including a host computer, a base station and a user equipment (UE) configured to support simultaneous connections to one or more serving cells in a first radio access network (RAN), using a first radio access technology (RAT) and to one or more serving cells in a second RAN, using a second RAT that differs from the first RAT, the method comprising:
at the host computer, providing user data; and
at the host computer, initiating a transmission carrying the user data to the UE via a cellular network comprising the base station, wherein the method comprises, at the UE:
   receiving, from a base station in the first RAN, using the first RAT, measurement configuration information, the measurement configuration information indicating whether radio measurements performed by the UE on one or more of the serving cells in the second RAN should be reported to the first RAN, using the first RAT; and
   selectively reporting measurement data for radio measurements performed by the UE on one or more of the serving cells in the second RAN to the first RAN, using the first RAT, in accordance with the measurement configuration information.

53. The method of example embodiment 52, further comprising:
at the UE, receiving the user data from the base station.

54. A communication system including a host computer comprising:
a communication interface configured to receive user data originating from a transmission from a user equipment (UE) to a base station,
wherein the UE is configured to support simultaneous connections to one or more serving cells in a first radio access network (RAN), using a first radio access technology (RAT) and to one or more serving cells in a second RAN, using a second RAT that differs from the first RAT, and wherein the UE comprises a radio interface and processing circuitry, the UE's processing circuitry configured to:
   receive, from a base station in the first RAN, using the first RAT, measurement configuration information, the measurement configuration information indicating whether radio measurements performed by the UE on one or more of the serving cells in the second RAN should be reported to the first RAN, using the first RAT; and
   selectively report measurement data for radio measurements performed by the UE on one or more of the serving cells in the second RAN to the first RAN, using the first RAT, in accordance with the measurement configuration information.

55. The communication system of example embodiment 54, further including the UE.

56. The communication system of example embodiment 55, further including the base station, wherein the base station comprises a radio interface configured to communicate with the UE and a communication interface configured to forward to the host computer the user data carried by a transmission from the UE to the base station.

57. The communication system of example embodiment 55 or 56, wherein:
the processing circuitry of the host computer is configured to execute a host application; and
the UE's processing circuitry is configured to execute a client application associated with the host application, thereby providing the user data.

58. The communication system of example embodiment 55 or 56, wherein:
the processing circuitry of the host computer is configured to execute a host application, thereby providing request data; and
the UE's processing circuitry is configured to execute a client application associated with the host application, thereby providing the user data in response to the request data.

59. A method implemented in a user equipment (UE) configured to support simultaneous connections to one or more serving cells in a first radio access network (RAN), using a first radio access technology (RAT) and to one or more serving cells in a second RAN, using a second RAT that differs from the first RAT, comprising:
receiving, from a base station in the first RAN, using the first RAT, measurement configuration information, the measurement configuration information indicating whether radio measurements performed by the UE on one or more of the serving cells in the second RAN should be reported to the first RAN, using the first RAT; and
selectively reporting measurement data for radio measurements performed by the UE on one or more of the serving cells in the second RAN to the first RAN, using the first RAT, in accordance with the measurement configuration information.

60. The method of example embodiment 59, further comprising:
providing user data; and
forwarding the user data to a host computer via the transmission to the base station.

61. A method implemented in a communication system including a host computer, a base station and a user equipment (UE) configured to support simultaneous connections to one or more serving cells in a first radio access network (RAN), using a first radio access technology (RAT) and to one or more serving cells in a second RAN, using a second RAT that differs from the first RAT, the method comprising:
at the host computer, receiving user data transmitted to the base station from the UE, wherein the method comprises, at the UE:
   receiving, from a base station in the first RAN, using the first RAT, measurement configuration information, the measurement configuration information indicating whether radio measurements performed by the UE on one or more of the serving cells in the second RAN should be reported to the first RAN, using the first RAT; and
   selectively reporting measurement data for radio measurements performed by the UE on one or more of the serving cells in the second RAN to the first RAN, using the first RAT, in accordance with the measurement configuration information.

62. The method of example embodiment 61, further comprising:
at the UE, providing the user data to the base station.

63. The method of example embodiment 62, further comprising:
at the UE, executing a client application, thereby providing the user data to be transmitted; and
at the host computer, executing a host application associated with the client application.

64. The method of example embodiment 62, further comprising:
at the UE, executing a client application; and
at the UE, receiving input data to the client application, the input data being provided at the host computer by executing a host application associated with the client application,
wherein the user data to be transmitted is provided by the client application in response to the input data.

65. A communication system including a host computer comprising a communication interface configured to receive user data originating from a transmission from a user equipment (UE) to a base station in a first radio access network (RAN), wherein the base station is configured to support simultaneous connections by a UE to the base station using a first radio access technology (RAT) and to one or more serving cells in a second RAN using a second RAT that differs from the first RAT, wherein the base station comprises a radio interface and processing circuitry, the base station's processing circuitry configured to send, to the UE, using the first RAT, measurement configuration information, the measurement configuration information indicating whether radio measurements performed by the UE on one or more of the serving cells in the second RAN should be reported to the first RAN, using the first RAT.

66. The communication system of example embodiment 65, further including the base station.

67. The communication system of example embodiment 66, further including the UE, wherein the UE is configured to communicate with the base station.

68. The communication system of example embodiment 67, wherein:
the processing circuitry of the host computer is configured to execute a host application;
the UE is configured to execute a client application associated with the host application, thereby providing the user data to be received by the host computer.

69. A method implemented in a communication system including a host computer, a base station and a user equipment (UE), the method comprising:
at the host computer, receiving, from the base station, user data originating from a transmission which the base station has received from the UE, wherein the method comprises, at the UE:
   receiving, from a base station in the first RAN, using the first RAT, measurement configuration information, the measurement configuration information indicating whether radio measurements performed by the UE on one or more of the serving cells in the second RAN should be reported to the first RAN, using the first RAT; and
   selectively reporting measurement data for radio measurements performed by the UE on one or more of the serving cells in the second RAN to the first RAN, using the first RAT, in accordance with the measurement configuration information.

70. The method of example embodiment 69, further comprising:
at the base station, receiving the user data from the UE.

71. The method of example embodiment 70, further comprising:
at the base station, initiating a transmission of the received user data to the host computer.

72. A wireless device configured to support simultaneous connections to one or more serving cells in a first radio access network (RAN), using a first radio access technology (RAT) and to one or more serving cells in a second RAN, using a second RAT that differs from the first RAT, the wireless device comprising:
a receiving module for receiving, from a base station in the first RAN, using the first RAT, measurement configuration information, the measurement configuration information indicating whether radio measurements performed by the wireless device on one or more of the serving cells in the second RAN should be reported to the first RAN, using the first RAT; and
a selectively reporting module for selectively reporting measurement data for radio measurements performed by the wireless device on one or more of the serving cells in the second RAN to the first RAN, using the first RAT, in accordance with the measurement configuration information.

73. A base station in a first radio access network (RAN), wherein the base station is configured to support simultaneous connections by a wireless device to the base station using a first radio access technology (RAT) and to one or more serving cells in a second RAN using a second RAT that differs from the first RAT, the base station comprising:
a sending module for sending, to the wireless device, using the first RAT, measurement configuration information, the measurement configuration information indicating whether radio measurements performed by the wireless device on one or more of the serving cells in the second RAN should be reported to the first RAN, using the first RAT.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the preceding examples of embodiments, the following claims, and their equivalents, and shall not be restricted or limited by the foregoing detailed description.

1-40. (canceled)

41. A method, in a wireless device configured to support simultaneous connections to one or more serving cells in a first radio access network (RAN) using a first radio access technology (RAT) and to one or more serving cells in a second RAN, using a second RAT that differs from the first RAT, the method comprising:
receiving, from a base station in the first RAN, using the first RAT, measurement configuration information, the measurement configuration information indicating whether radio measurements performed by the wireless device on one or more of the serving cells in the second RAN should be reported to the first RAN, using the first RAT; and
selectively reporting measurement data for radio measurements performed by the wireless device on one or more of the serving cells in the second RAN to the first RAN, using the first RAT, in accordance with the measurement configuration information.

42. The method of claim 41, wherein the base station in the first RAN is acting as a master node in a multi-RAT dual-connectivity (DC) connection with the wireless device.

43. The method of claim 41, wherein the first RAT is Long-Term Evolution (LTE) and the second RAT is NR.

44. The method of claim 41, wherein the measurement configuration information further specifies whether the radio measurements performed by the wireless device on one or more of the serving cells in the second RAN should include cell-based measurements or beam-based measurements, or both.

45. The method of claim 41, wherein the measurement configuration information further specifies whether the radio measurements performed by the wireless device on one or more of the serving cells in the second RAN should be based on a first reference signal (RS) type or a second RS type or both first and second RS types.

46. The method of claim 45, wherein the first RS type is a channel state information reference signal (CSI-RS) type and the second RS type is a reference signal included in a synchronization signal/physical broadcast channel block (SS/PBCH block).

47. The method of claim 41, wherein the measurement configuration information further specifies reporting conditions for reporting the measurement data for the radio measurements performed by the wireless device on the one or more of the serving cells in the second RAN, wherein the reporting conditions comprise a periodic reporting requirement, a threshold-based reporting trigger, or both.

48. The method of claim 41, wherein the measurement configuration information further specifies whether or not radio measurements performed by the wireless device on one or more of the serving cells in the first RAN should be reported to the second RAN, using the second RAT.

49. A method, in a base station in a first radio access network (RAN) wherein the base station is configured to support simultaneous connections by a wireless device to the base station using a first radio access technology (RAT) and to one or more serving cells in a second RAN using a second RAT that differs from the first RAT, the method comprising:
sending, to the wireless device, using the first RAT, measurement configuration information, the measurement configuration information indicating whether radio measurements performed by the wireless device on one or more of the serving cells in the second RAN should be reported to the first RAN, using the first RAT.

50. The method of claim 49, wherein the measurement configuration information indicates that radio measurements performed by the wireless device on one or more of the serving cells in the second RAN should be reported to the first RAN, using the first RAT, the method further comprising receiving, from the wireless device, measurement data for radio measurements performed by the wireless device on one or more of the serving cells in the second RAN.

51. The method of claim 49, wherein the measurement configuration information further specifies whether the radio measurements performed by the wireless device on one or more of the serving cells in the second RAN should include cell-based measurements or beam-based measurements, or both.

52. The method of claim 49, wherein the measurement configuration information further specifies whether the radio measurements performed by the wireless device on one or more of the serving cells in the second RAN should be based on a first reference signal (RS) type or a second RS type or both first and second RS types.

53. The method of claim 49, wherein the measurement configuration information further specifies reporting conditions for reporting the measurement data for the radio measurements performed by the wireless device on the one or more of the serving cells in the second RAN, wherein the reporting conditions comprise a periodic reporting requirement, a threshold-based reporting trigger, or both.

54. The method of claim 49, wherein the measurement configuration information further specifies whether or not radio measurements performed by the wireless device on one or more of the serving cells in the first RAN should be reported to the second RAN, using the second RAT.

55. A wireless device configured to support simultaneous connections to one or more serving cells in a first radio access network (RAN) using a first radio access technology (RAT) and to one or more serving cells in a second RAN, using a second RAT that differs from the first RAT, the wireless device comprising:
transceiver circuitry configured for communicating with the serving cells in the first and second RANs; and
processing circuitry operatively associated with the transceiver circuitry and configured to:
receive, from a base station in the first RAN, using the first RAT, measurement configuration information, the measurement configuration information indicating whether radio measurements performed by the wireless device on one or more of the serving cells in the second RAN should be reported to the first RAN, using the first RAT; and
selectively report measurement data for radio measurements performed by the wireless device on one or more of the serving cells in the second RAN to the first RAN, using the first RAT, in accordance with the measurement configuration information.

56. The wireless device of claim 55, wherein the base station in the first RAN is acting as a master node in a multi-RAT dual-connectivity (DC) connection with the wireless device.

57. The wireless device of claim 55, wherein the measurement configuration information further specifies whether the radio measurements performed by the wireless device on one or more of the serving cells in the second RAN should include cell-based measurements or beam-based measurements, or both.

58. The wireless device of claim 55, wherein the measurement configuration information further specifies whether the radio measurements performed by the wireless device on one or more of the serving cells in the second RAN should be based on a first reference signal (RS) type or a second RS type or both first and second RS types.

59. The wireless device of claim 58, wherein the first RS type is a channel state information reference signal (CSI-RS) type and the second RS type is a reference signal included in a synchronization signal/physical broadcast channel block (SS/PBCH block).

60. The wireless device of claim 55, wherein the measurement configuration information further specifies reporting conditions for reporting the measurement data for the radio measurements performed by the wireless device on the one or more of the serving cells in the second RAN, wherein the reporting conditions comprise a periodic reporting requirement, a threshold-based reporting trigger, or both.

61. The wireless device of claim 55, wherein the measurement configuration information further specifies whether or not radio measurements performed by the wireless device on one or more of the serving cells in the first RAN should be reported to the second RAN, using the second RAT.

62. A base station for operation in a first radio access network (RAN) wherein the base station is configured to support simultaneous connections by a wireless device to the base station using a first radio access technology (RAT) and to one or more serving cells in a second RAN using a second RAT that differs from the first RAT, the base station comprising:
transceiver circuitry configured for communicating with the wireless device; and
processing circuitry operatively associated with the transceiver circuitry and configured to:
send, to the wireless device, using the first RAT, measurement configuration information, the measurement configuration information indicating whether radio measurements performed by the wireless device on one or more of the serving cells in the second RAN should be reported to the first RAN, using the first RAT.

63. The base station of claim 62, wherein the base station in the first RAN is acting as a master node in a multi-RAT dual-connectivity (DC) connection with the wireless device.

64. The base station of claim 62, wherein the measurement configuration information further specifies whether the radio measurements performed by the wireless device on one or more of the serving cells in the second RAN should include cell-based measurements or beam-based measurements, or both.

65. The base station of claim 62, wherein the measurement configuration information further specifies whether the radio measurements performed by the wireless device on one or more of the serving cells in the second RAN should be based on a first reference signal (RS) type or a second RS type or both first and second RS types.

66. The base station of claim 62, wherein the measurement configuration information further specifies whether or not radio measurements performed by the wireless device on one or more of the serving cells in the first RAN should be reported to the second RAN, using the second RAT.
